(19) United States
(12) Patent Application Publication
(10) Pub. No.: US 2024/0251839 A1
(43) Pub. Date: Aug. 1, 2024

(54) CLEAN-IN-PLACE AUTOMATED JUICING MACHINES AND RELATED METHODS

(71) Applicant: Goodnature Products, Inc., Buffalo, NY (US)

(72) Inventors: Dale Wettlaufer, Buffalo, NY (US); Richard Hess, South Wales, NY (US)

(21) Appl. No.: 18/424,499

(22) Filed: Jan. 26, 2024

Related U.S. Application Data
(60) Provisional application No. 63/620,735, filed on Jan. 12, 2024.
(60) Provisional application No. 63/482,001, filed on Jan. 27, 2023.

(51) Int. Cl. A23N 1/02; B08B 3/02; B08B 9/093

(52) U.S. Cl. CPC A23N 1/02; B08B 3/02; B08B 9/093; B08B 2209/08; B08B 2209/085

(57) ABSTRACT

Various juicing machines, systems, and methods are disclosed. The juicing machines described herein can automatically grind and press food to extract juice. The juicing machines described herein can automatically self-clean and recirculate fluid for cleaning.

### CROSS REFERENCE

This application claims the priority benefit of U.S. Provisional Application No. 63/620,735, filed Jan. 12, 2024, and U.S. Provisional Application No. 63/482,001, filed Jan. 27, 2023, which are hereby incorporated by reference in their entireties. All applications for which a foreign or domestic priority is identified in the Application Data Sheet as filed with the present application are hereby incorporated by reference under 37 CFR 1.57. Additionally, the juicing devices and methods disclosed herein can include any of the features disclosed in U.S. Pat. No. 11,844,466 and U.S. Patent Application Publication No. 2023/0218101, which are also incorporated by reference in their entireties.

### FIELD

This disclosure relates to juicing machines, such as automated cold press juicing machines with clean-in-place functionality.

### SUMMARY OF CERTAIN FEATURES

Juice is a natural way to provide not only a delicious beverage but also valuable nutrition to the human body. For example, juice can provide essential minerals, vitamins, and other beneficial compounds. Using cold press juicing techniques can preserve essential minerals, vitamins, other beneficial compounds, and provide enhanced natural flavor compared to other juicing techniques.

At least due to the foregoing reasons, more people are consuming cold pressed juices. Accordingly, there is an increasing demand to quickly produce large quantities of cold pressed juices while maintaining superior quality. The current techniques of cold pressing juices are slow, laborious, expensive, and/or require large presses that are difficult to ship, setup, and/or maneuver. Current techniques rely on significant human intervention to operate and clean large presses, which can be time consuming, inefficient, wasteful, and/or expensive.

Various juicing machines are disclosed herein that address one or more of the problems detailed above, or other problems. Several of the juicing machines disclosed automatically grind and press food to produce cold pressed juice, which significantly reduces the need for human intervention and improves volume of output. Automatically grinding and pressing food can include grinding and pressing food without further human intervention after initiating a juicing process (e.g., instructing the juicing machine to start a juicing process). For example, in an automated grinding process, a human is not needed to operate the grinder, to collect food discharged from the grinder, and/or to control the flow of ground food into the press machine. As another example, in an automated pressing process, a human is not needed to load ground food into bags in the press machine, to extend a press that compresses the bags to extract juice, to retract the press, to collect the juice, and/or to discharge the cake (the remnant of the pressed ground food) from the bags. In an automated cleaning process, a human is not needed to rinse ground food from the bags, to clean (e.g., sanitize) the bags (e.g., by submerging the bags), and/or to rinse and/or clean the interior of the pressing machine. In various embodiments, the pressing machine can automatically perform one or more (including all combinations) of the above-described steps.

The juicing machines described herein can include a grinder assembly with a chute. Food (e.g., fruits, vegetables, etc.) can be loaded into the chute by way of an operator, elevator, and/or conveyor. The food in the chute can be ground (e.g., cut, shredded, etc.) by the grinder assembly. The ground food can flow from the grinder assembly into a hopper. The hopper can include a barrier that inhibits or prevents solids from the ground food from flowing out of an outlet of the hopper and into a press assembly for pressing.

The juicing machine can include a sensor at the hopper that receives the ground food. The sensor can be a load sensor (e.g., strain gauge) that can monitor the quantity (e.g., weight) of ground food held in the hopper. The computing device of the juicing machine or an external computing device in communication with the computing device can utilize data from the sensor at the hopper to operate the grinder assembly (e.g., start/stop grinding operation), equipment (e.g., conveyor, elevator) delivering food to the chute of the grinder assembly, and/or actuation of the barrier to release the ground food through the outlet of the hopper. For example, the juicing machine can actuate the barrier to release the ground food from the hopper for pressing when a quantity (e.g., weight) of food is detected. The grinder assembly can include a sensor, such as a load sensor (e.g., strain gauge), that can monitor the quantity (e.g., weight, volume, mass, etc.) of food in the grinder assembly (e.g., chute of the grinder assembly). A computing device (e.g., programmable logic controller) of the juicing machine or an external computing device in communication with the computing device can utilize data provided by the sensor at the grinder assembly to control the operation of the grinder assembly (e.g., start/stop grinding operation), equipment (e.g., conveyor, elevator) delivering food to the chute of the grinder assembly, and/or actuation of the barrier to release the ground food through the outlet of the hopper. For example, the grinder may stop grinding when a quantity of food has been ground and/or when the chute of the grinder assembly is empty.

When a quantity of ground food is disposed in the hopper, the computing device can actuate the barrier to uncover (e.g., open, unobscure, reveal, etc.) the outlet of the hopper such that the ground food flows out of the hopper and into the chamber of a press assembly of the juicing machine. In some embodiments, the ground food can flow into bags disposed in the press assembly, such as between wall inserts of the press assembly.

The press assembly can include a sensor, such as a load sensor (e.g., strain gauge) to monitor the quantity of ground food held by the press assembly. The computing device of the juicing machine or an external computing device in communication with the computing device can utilize data from the sensor at the press assembly to operate the press assembly. For example, when a quantity of ground food is in the press assembly (e.g., a quantity that corresponds to that detected by one or more of the sensor(s) at the grinder assembly and/or hopper), the press assembly can initiate a pressing cycle (e.g., procedure). The pressing cycle can include advancing a movable platen (e.g., wall) to squeeze the ground food disposed in the chamber of the press assembly. The speed of advancement and/or force applied by the movable platen can depend on the quantity of food and/or type of food (e.g., fibrous, non-fibrous, soft, hard, etc.) being pressed.

The juice pressed from the ground food can flow out of the chamber of the press assembly and into a receptacle. The computing device can determine juice yield by comparing the weight data provided by one or more sensor(s) at the grinder assembly and/or hopper with the weight data provided by the sensor at the press assembly. The juicing machine can include a pump that can pump juice in the receptacle into a container for storing juice. The juicing machine can include a screen (e.g., angled screen) disposed over the receptacle to impede solids from entering the receptacle. The screen can be angled such that solids slide off the screen as opposed to building up thereon and impeding the flow of juice into the receptacle.

After pressing juice from the ground food, the de-juiced food material can be a leftover cake, which may be considered a waste product (e.g., cakes, dry cakes, etc.). The cake waste can remain in the chamber (e.g., bags) of the pressing assembly. Currently, the waste is removed by way of human intervention, such as by a person or persons manually removing the bag from the pressing assembly and removing (e.g., inverting) the waste from the bag. The juicing machines described herein can automatically remove the waste. For example, when the press cycle is complete, the movable platen can retract and the press assembly can be inverted to dump the waste from inside the chamber (e.g., from inside the bags). In several embodiments, the waste can be removed while maintaining the bags in the pressing assembly and/or without removing the bags from the pressing assembly. The juicing machine can include a motor (e.g., step motor) that can rotate the press assembly to an inverted position to dump the waste, such as by gravity. The sensor at the press assembly can detect when the waste has been dumped. A container can be disposed under the press assembly to catch the dumped waste. In some embodiments, a conveyor can be disposed under the press assembly to catch the dumped waste and convey it away. The waste can be collected and used, such as for animal feed, fertilizer, or otherwise.

With the waste removed, the juicing machine can automatically prepare to receive another portion of ground food. In some embodiments, the juicing machine can rotate the press assembly to a position to receive another portion of ground food. For example, the press assembly can move to an upright position (e.g., position an opening into the chamber of the press assembly below the outlet of the hopper).

In some embodiments, the juicing machine can spray the press assembly (e.g., bags of the press assembly) with fluid, such as while the press assembly is inverted and/or is being rotated back to the upright position to receive more ground food. For example, the juicing machine can include one or more nozzles that can spray fluid. The sprayed fluid can inhibit or prevent build up inside the bags (e.g., dissolve pectin, sugar, etc.).

In various embodiments, the pressing machine is configured for parallel processing of various operations in the juicing process. While the juicing machine is pressing the ground food, the juicing machine can simultaneously be grinding additional food for pressing. While the juicing machine is dumping waste, the juicing machine can simultaneously be grinding additional food for pressing. In some embodiments, the grinder assembly can be operating (e.g., grinding food) continuously when producing juice. Accordingly, with the press assembly in the upright position, the barrier of the hopper can be retracted to permit ground food to flow into the chamber of the press chamber for pressing.

The juicing machine can automatically repeat one or more of the aforementioned steps and processes, or others, until a quantity of food has been pressed, a period has elapsed, a number of pressing cycles have been performed, or another threshold has been reached. In some embodiments, the receptacle that holds the pressed juice can include a load sensor (e.g., strain gauge) to monitor a quantity of juice. In some embodiments, the juicing machine can automatically repeat the steps until a quantity of pressed juice has been produced. In some embodiments, the juicing machine can automatically repeat the steps until no additional food is being delivered to the grinder assembly.

The juicing machines described herein can self-clean, which can be referred to as a “clean-in-place” (CIP) process. The computing device can initiate a self-clean when juicing is complete, which can at least be based on the criteria described herein. The juicing machines described herein can include one or more features to automatically clean (e.g., wash, rinse, and/or sanitize) one or more components of the juicing machine, which can include the pressing assembly, chamber, bag(s), press wall(s), ramp(s), hopper(s), chute(s), grinder assembly, grinder(s), receptacle(s), ramp(s), barrier(s), outlet(s), inlet(s), etc. For example, the juicing machine can include one or more conduits and/or fluid outlets (e.g., nozzles, spouts, hoses) that can direct fluid (e.g., water, cleaning agents, solvents, sanitizing agents, etc.) to the one or more components. The juicing machine can include one more fluid outlets to spray the one or more components with fluid. The juicing machine can clean the bags without removing the bags from the juicing machine. Thus, rather than needing to disconnect and remove the bags from the press machine for cleaning (e.g., in a separate washing machine), the bags can remain in place and be cleaned in the juicing machine itself. This can provide a significant time and labor savings, increase the time that the juicing machine is making juice, and/or reduce the chance of damage to the juice machine and/or the bags.

In some embodiments, the press chamber can be partially or fully filled with a fluid to facilitate cleaning as part of the CIP process or otherwise. For example, a fluid outlet can spray fluid into the press chamber to fill the press chamber and submerge at least a portion of the bags in fluid. A valve at the outlet of the press chamber can be closed to permit filling of the press chamber. The moveable platen can be advanced and/or retracted to move the bags and wall inserts, which can agitate the fluid in the press chamber, to facilitate cleaning. The fluid can be emptied out of the pressing chamber by opening the valve at the outlet and/or rotating the pressing chamber to an inverted position to dump the fluid. Fluid emptied by way of the valve can flow into the receptacle that is used for collecting juice. Fluid dumped out of the pressing chamber can fall onto a ramp that is angled to direct fluid into the receptacle. As described herein, the screen over the receptacle can impede solids from flowing into the receptacle.

The fluid in the receptacle can be recirculated for cleaning. For example, the juicing machine can utilize the pump that pumps juice from the receptacle to the container to pump the fluid from the receptacle back to the one or more conduits and/or fluid outlets (e.g., nozzles) for cleaning. In some embodiments, the pump can pump fluid from the receptacle to a booster pump that directs the fluid to a manifold that can direct the fluid through one of a plurality of conduits to spray components of the juicing machine. In some embodiments, a self-cleaning cycle can be based on a period of time. In some embodiments, the juicing machine can utilize the load sensors to detect if waste remains in the juicing machine (e.g., a quantity of waste is above a threshold) and, if so, continue self-cleaning but, if not, cease self-cleaning. When cleaning is complete, the pump can pump fluid from the receptacle to a drain or tank. In some embodiments, fluid can flow from the manifold to a drain or tank.

In some aspects, a juicing machine is disclosed herein. The juicing machine can include a grinder that can grind food. The juicing machine can include a press assembly including a chamber, a moveable platen disposed in the chamber, and/or a press shaft. The chamber can include an outlet and be configured to receive the ground food from the grinder. The press shaft can advance the moveable platen to press the ground food received in the chamber to extract juice. The juicing machine can include a receptacle configured to receive extracted juice flowing out of the chamber through the outlet. The juicing machine can include a motor that can rotate the press assembly to an inverted position to dump waste remaining in the chamber from the chamber after the ground food is pressed.

In some aspects, the juicing machine can include a hopper to receive ground food and a load sensor that can monitor a weight of food disposed in the hopper.

In some aspects, the juicing machine can include a load sensor that can monitor a weight of the food in the chamber.

In some aspects, the juicing machine can include a plurality of wall inserts and a plurality of bags disposed in the chamber. The plurality of bags can be disposed between adjacent wall inserts of the plurality of wall inserts and can receive the cut food.

In some aspects, the plurality of wall inserts can be coupled together by linkages.

In some aspects, one wall insert of the plurality of wall inserts can be coupled to an end wall of the chamber and another wall insert of the plurality of wall inserts can be coupled to the moveable platen.

In some aspects, the juicing machine can include a rod that can extend through the chamber. The plurality of wall inserts can include holes that can receive the rod.

In some aspects, the juicing machine can include a hopper that can receive cut food from the grinder above the press assembly. The hopper can include a barrier that can be actuated to cover and uncover an outlet of the hopper.

In some aspects, the juicing machine can include a screen disposed over the receptacle to impede solids from entering the receptacle.

In some aspects, the juicing machine can include one or more fluid outlets that can spray a fluid to clean the press assembly.

In some aspects, the juicing machine can include one or more pumps to recirculate the fluid back to the one or more fluid outlets.

In some aspects, a juicing machine is disclosed herein. The juicing machine can include a chamber that can receive food. The juicing machine can include a moveable platen disposed in the chamber. The juicing machine can include a press shaft that can advance the moveable platen to press food received in the chamber to extract juice. The juicing machine can include a motor that can rotate the chamber to an inverted position to dump waste remaining in the chamber after the food is pressed to extract juice.

In some aspects, the juicing machine can include a load sensor that can monitor a weight of food disposed in the chamber.

In some aspects, the juicing machine can include a plurality of wall inserts and a plurality of bags disposed in the chamber. The plurality of bags can be disposed between adjacent wall inserts of the plurality of wall inserts and receive the food.

In some aspects, the plurality of wall inserts can be coupled together by linkages.

In some aspects, one wall insert of the plurality of wall inserts can be coupled to an end wall of the chamber and another wall insert of the plurality of wall inserts can be coupled to the moveable platen.

In some aspects, the juicing machine can include a grinder and a hopper. The grinder can cut food. The hopper can receive the cut food from the grinder above the chamber and include a barrier that can be actuated to cover and uncover an outlet of the hopper.

In some aspects, the juicing machine can include one or more fluid outlets that can spray a fluid to clean the chamber.

In some aspects, the juicing machine can include one or more pumps to recirculate the fluid back to the one or more fluid outlets.

In some aspects, a juicing machine is disclosed herein. The juicing machine can include a grinder that can cut food, an enclosure, a press assembly disposed in the enclosure. The press assembly can include a water-tight chamber that can hold press bags for receiving the cut food. The press assembly can press the cut food received in the press bags to extract juice. The juicing machine can include one or more fluid outlets disposed in the enclosure. The one or more fluid outlets can spray a fluid into the water-tight chamber to clean the bags. The juicing machine can include one or more pumps that can recirculate the fluid back to the one or more fluid outlets.

In some aspects, a press machine is disclosed herein. The press machine can include a water-tight chamber that can hold bags that receive food. The press machine can include a moveable platen disposed in the water-tight chamber that can be advanced to press food received in the bags to extract juice. The press machine can include one or more fluid outlets that can direct fluid into the water-tight chamber to at least partially submerge the bags in the water-tight chamber.

In some aspects, a press machine is disclosed herein. The press machine can include a water-tight chamber that can hold bags that receive food for pressing. The press machine can include one or more fluid outlets that can direct fluid into the water-tight chamber. The press machine can perform a first cleaning stage and a second cleaning stage. In the first cleaning stage, the one or more fluid outlets can spray the water-tight chamber and the bags for cleaning. In the second cleaning stage, the one or more fluid outlets can fill the water-tight chamber to at least partially submerge the bags in the water-tight chamber.

In some aspects, a method of cleaning a press machine is disclosed herein. The method can include rotating a chamber of the press machine disposed within an enclosure of the press machine to an inverted position. The method can include dumping waste out of bags disposed in the chamber. The method can include rotating the chamber from the inverted position toward an upright position. The method can include spraying the chamber and the bags with a fluid. The method can include filling the chamber with the fluid to at least partially submerge the bags.

In some aspects, the method can include advancing and retracting a moveable platen to agitate the fluid filling the chamber.

Neither the preceding summary nor the following detailed description purports to limit or define the scope of protection. The scope of protection is defined by the claims.

### BRIEF DESCRIPTION OF THE DRAWINGS

The abovementioned and other features of the embodiments disclosed herein are described below with reference to the drawings of the embodiments. The illustrated embodiments are intended to illustrate, but not to limit, the scope of protection. Various features of the different disclosed embodiments can be combined to form further embodiments, which are part of this disclosure.

FIGS. 1A and 1B illustrate various views of a juicing machine.

FIG. 2 illustrates an exploded view of a grinder assembly of the juicing machine.

FIGS. 3A and 3B illustrate various views of an example grinder of the grinder assembly.

FIG. 4 illustrates a section view of the grinder assembly.

FIGS. 5A and 5B illustrate various views of a hopper of the juicing machine.

FIG. 5C illustrates a section view of the hopper.

FIG. 6 illustrates the juicing machine with part of an enclosure not shown such that a press assembly is shown.

FIG. 7 illustrates a section view of a ramp and a receptacle of the juicing machine.

FIG. 8 illustrates the press assembly with a piston retracted.

FIG. 9A illustrates a section view of the press assembly showing the moveable platen assembly.

FIG. 9B illustrates a section view of the press assembly showing an end wall of a chamber of the press assembly.

FIGS. 10A and 10B illustrate front and rear views of the moveable platen assembly.

FIG. 11 illustrates bags disposed between linked wall inserts of the press assembly.

FIGS. 12A and 12B illustrate an example of the wall inserts of the press assembly.

FIGS. 13A and 13B illustrate another example of the wall inserts of the press assembly.

FIG. 13C illustrates another example of the wall inserts of the press assembly.

FIG. 14A illustrates a section view of the juicing machine showing a wall insert coupled to the platen of the moveable platen assembly.

FIG. 14B illustrates a section view of the juicing machine showing a wall insert coupled to the end wall of the chamber of the press assembly.

FIGS. 15A-15C illustrate various views of a bag of the press assembly.

FIG. 16 illustrates a section view of the juicing machine showing the bag disposed in the pressing chamber and coupled to a rod.

FIG. 17 illustrates a section view of the pressing chamber.

FIG. 18 illustrates the press assembly with the press shaft extended.

FIG. 19 illustrates a drive assembly that can rotate the press assembly.

FIG. 20 illustrates a sensor system to monitor the rotation position of the press assembly.

FIG. 21 illustrates the press assembly rotated to an intermediate position between an upright position, such as illustrated in FIG. 6, and an inverted position, such as illustrated in FIG. 22.

FIG. 22 illustrates the press assembly rotated to an inverted position.

FIGS. 23A-23C illustrate the press assembly progressively rotating to the inverted position to dump waste material.

FIG. 24A illustrates a view of the juicing machine with part of the enclosure removed to show a manifold to recirculate fluid during self-cleaning.

FIG. 24B illustrates a view of the juicing machine with part of the enclosure removed to show a pump to recirculate fluid during self-cleaning and a hydraulic system to acuate the piston of the press assembly.

FIG. 24C illustrates a section view of the juicing machine shown a nozzle spraying inside the chamber of the press assembly during self-cleaning.

FIGS. 25A and 25B illustrate fluid spraying the bags of the press assembly during self-cleaning.

FIG. 26 schematically illustrates the flow of fluid during self-cleaning.

### DETAILED DESCRIPTION OF CERTAIN EMBODIMENTS

Although certain embodiments and examples are described below, this disclosure extends beyond the specifically disclosed embodiments and/or uses and obvious modifications and equivalents thereof. Thus, it is intended that the scope of this disclosure should not be limited by any particular embodiments described below.

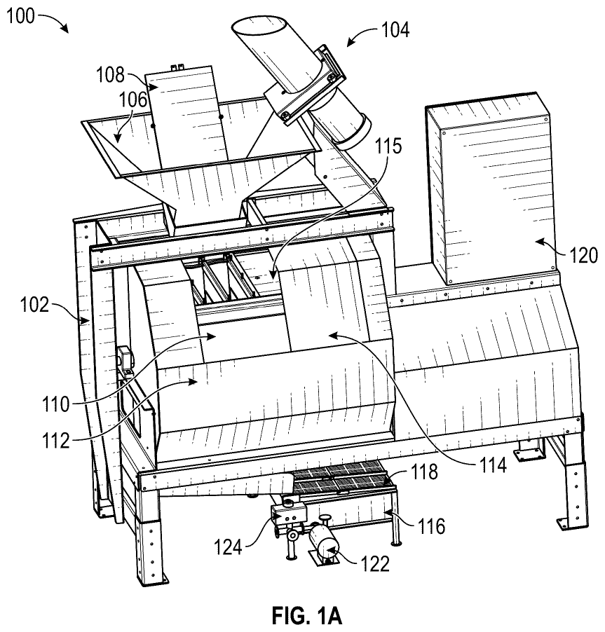

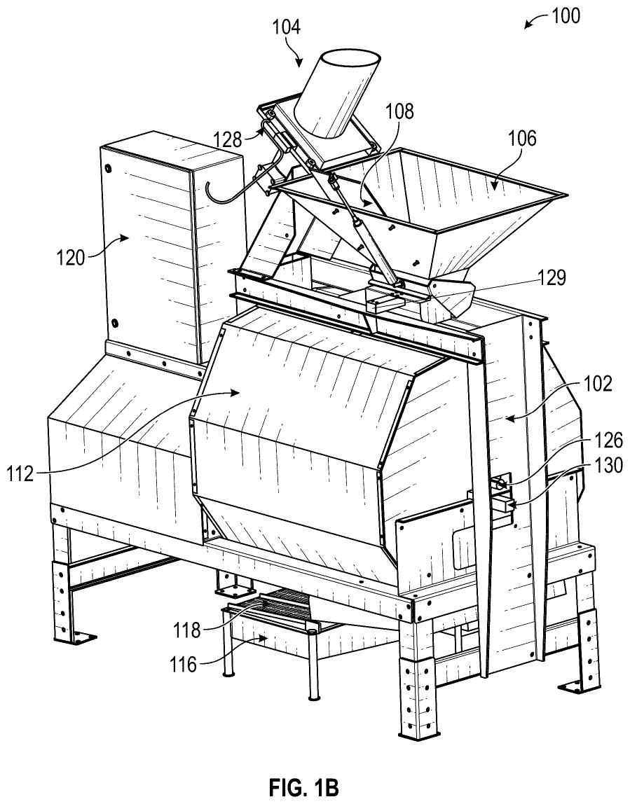

### A. JUICING MACHINE OVERVIEW—FIG. 1A AND 1B

Various embodiments and configurations of a juicing machine 100 are disclosed herein. FIGS. 1A and 1B illustrate an example of the juicing machine 100, which can also be referred to as a juicer device, juicer machine, juicing machine, press, pressing machine, juice press, and/or juice pressing machine. The juicing machine 100 can process food to extract juices. Food can include any plant or animal product that has a juice that is consumable by humans.

As illustrated, the juicing machine 100 can include a grinder assembly 104, which can also be referred to as a grinder, shredder, cutter, cutting assembly, and/or shredding assembly. The grinder assembly 104 can grind, which can include cut and/or shred, food into smaller fragments. As illustrated in FIG. 1B, the grinder assembly 104 can include a safety switch 128 (e.g., contact sensor, safety sensor). The safety switch 128 can confirm that a grinder of the grinder assembly 104 is covered prior to rotating the grinder to grind food. In some embodiments, the safety switch 128 can be a load cell (e.g., strain gauge) that can sense a quantity (e.g., weight) of food in the grinder assembly 104 and/or processed by the grinder assembly 104. Data from a load cell at the grinder assembly 104 can be use by the computing device 120 to trigger one or more automated actions described herein.

The juicing machine 100 can include a hopper 106, which can also be referred to as a vessel, holder, and/or receptacle. The food ground by the grinder assembly 104 can flow into the hopper 106. The hopper 106 can include a valve or barrier 108 (e.g., wall, door, guillotine door, panel) that can block an outlet of the hopper 106 to impede solid ground food from flowing out of the hopper 106. The barrier 108 can be automatically actuated by the computing device 120. As illustrated in FIG. 1B, the juicing machine 100 can include a load sensor 129 (e.g., strain gauge) disposed at the hopper 106 that can sense weight and/or other data. The load sensor 129 can be used by the juicing machine 100 to determine a quantity (e.g., weight) of food in the hopper 106 and/or food ground by the grinder assembly 104. The load sensor 129 can be disposed on the frame 102 and under the hopper 106. Data from the load sensor 129 can be communicated to a computing device 120 (e.g., programmable logic controller) of the juicing machine 100. The computing device 120 can actuate the barrier 108 of the hopper 106, control a device (e.g., conveyor, elevator) feeding food to the grinder assembly 104, and/or operate the grinder assembly 104. For example, the computing device 120 can instruct actuation of the barrier 108 to uncover (e.g., stop blocking) an outlet of the hopper 106 allow ground food to flow out of the hopper 106 based on a sensed quantity (e.g., threshold quantity, weight) of ground food in the hopper 106. The computing device 120 can instruct the actuation of the barrier 108 to cover (e.g., block) an outlet of the hopper 106 to hold ground food from the grinder assembly 104 based on weight data provided by the sensor 129. For example, if the sensed weight falls below a threshold, the computing device 120 can instruct the barrier 108 to cover the outlet of the hopper 106 (e.g., if the hopper 106 is emptied, the barrier 108 can be moved to cover the outlet of the hopper 106 to fill the hopper 106 with ground food from the grinder assembly 104). In some embodiments, the grinder assembly 104 can stop grinding food when a threshold quantity of food is detected in the hopper 106. The computing device 120 can receive an input (e.g., from a user input device, such as a keyboard, touch screen, button(s), or otherwise) regarding the thresholds to trigger any of the automated actions described herein.

In some embodiments, food can be delivered to the grinder assembly 104 automatically by a conveyor, elevator, and/or the like. The computing device 120 can, in some embodiments, control the conveyor, elevator, and/or the like based on data provided by the load sensor 129 to the computing device 120. For example, when a threshold quantity of food is detected in the hopper 106, the computing device 120 can instruct the conveyor, elevator, and/or the like to stop delivering food to the grinder assembly 104. When a threshold quantity of food is not detected in the hopper 106, the computing device 120 can instruct the conveyor, elevator, and/or the like to stop delivery food to the grinder assembly 104. When a threshold quantity of food is detected in the hopper 106, the computing device can instruct the grinder assembly 104 to stop grinding food.

The juicing machine 100 can include a press assembly 110, which can also be referred to as a press, squeeze assembly, and/or squeezer. As shown, the press assembly 110 can be positioned below the grinder assembly 104 and/or hopper 106. The press assembly 110 can receive the ground food (e.g., catch falling ground food), such as from the grinder assembly 104 and/or hopper 106. The press assembly 110 can be disposed in an enclosure 112 (e.g., housing), which can help contain thrown or gushing juice, food, and/or fluid. The ground food can fall from the hopper 106 through an opening 115 in the enclosure 112 into the press assembly 110. The enclosure 112 can include a door 114 (e.g., window) that can be opened (e.g., slide or rotate open) to provide access to the press assembly 110.

The press assembly 110 can press (e.g., squeeze) the ground food to extract juice. For example, the press assembly 110 can include a movable platen that advances to press (e.g., squeeze) the ground food to extract juice.

The press assembly 110 can include a load sensor 130 (e.g., strain gauge) that can sense weight. The load sensor 130 can be disposed beneath a shaft 126 (e.g., rod, axle) supporting the press assembly 110. For example, the load sensor 130 can be coupled to a frame 102 of the juicing machine 100 that supports the press assembly 110 to measure load. The load sensor 130 can be used by the juicing machine 100 to determine a quantity (e.g., weight) of the ground food in the press assembly 110. Data from the load sensor 130 can be communicated to the computing device 120. The computing device 120 can utilize data provided by the load sensor 130 to operate the press assembly 110. For example, the computing device 120 can adjust a pressing cycle (e.g., speed, force) based on the detected quantity of food in the press assembly 110. The computing device 120 can determine juice yield by comparing load data provided by the load sensor 129 at the hopper 106 and the load sensor 130 at the press assembly 110. The computing device 120 can compare the weight of food held in the press assembly 110 prior to extracting juice and after extracting juice, which can be used to determine the weight of extracted juice.

The juicing machine 100 can include a receptacle 116, which can also be referred to as a tank, vessel, and/or container. The juice extracted from the ground food can flow out of the press assembly 110 by way of an outlet and into the receptacle 116. For example, the juice can fall from the outlet and into the receptacle 116. The receptacle 116 can include a screen 118 (e.g., angled screen, filter) disposed over the receptacle 116. The screen 118 can impede solids (e.g., solid food, ground food) from entering the receptacle 116. The screen 118 can be disposed at an angle such that solids slide off the screen 118 to reduce the likelihood that solids will build up on the screen 118 and impede the flow of fluid (e.g., juice) therethrough. The screen 118 can be a wedge wire screen.

The juicing machine 100 can include a pump 122. The pump 122 can pump juice from the receptacle 116. The pump 122 can pump juice from the receptacle 116 and into a container to store juice, such as a customer container for shipping. The pump 122 can be fluidically coupled to a valve 124 (e.g., three-way valve). The valve 124 can actuate to direct fluid from the pump 122 to the container to store juice or, as described herein, to recirculate cleaning fluid from the receptacle 116 back to the juicing machine 100 for self-cleaning.

After the press assembly 110 has pressed ground food to extract juice, waste, which can be referred to as cakes or dry cakes, can remain in the press assembly 110. The load sensor 130 can detect when waste material remains in the press assembly 110. The computing device 120 can command and/or control a motor (e.g., stepper motor) to rotate the press assembly 110. The press assembly 110 can be moved to an inverted position such that the waste falls downward out of the press assembly 110. In some embodiments, a container, such as a tote, can be disposed beneath the press assembly 110 to catch waste material. In some embodiments, a conveyor can catch and transport waste material from below the press assembly 110. The load sensor 130 can detect that the waste material has been removed, and in response, the computing device 120 can instruct the motor to rotate the press assembly 110, such as to an upright position to receive additional ground food material from the hopper 106. In some embodiments, the juicing machine 100 can include a fluid outlet that can spray the press assembly 110 as the press assembly 110 is in the inverted position and/or rotates from the inverted position to the upright position to help clean (e.g., remove pectin, sugar, etc.) the press assembly 110 prior to another press cycle.

The grinder assembly 104 can be grinding food while a press cycle is being carried out, the press assembly 110 is being rotated to dump waste material, and/or the press assembly 110 is being rotated back to an upright position. Such parallel operation can increase juice output of the juicing machine 100, increase efficiency, and/or reduce delay. In some embodiments, the grinder assembly 104 can intermittently or continuously grind food when the juicing machine 100 is being used to produce juice (e.g., during a pressing, dumping, and/or cleaning operation).

The juicing machine 100 can include a frame 102. The frame 102 can include one or more struts, beams, supports, bars, fasteners, bolts, footings, etc. to support the components of the juicing machine 100 in the arrangement as illustrated. In various embodiments, the frame is configured for easy disassembly. For example, in some implementations the frame 102 is constructed with few or no welds such that the various components of the frame can be disassembled from each other.

The processes described herein can be controlled by the computing device 120 and/or an external computing device (e.g., portable electronic device, tablet, desktop, smartphone, laptop, smartwatch, programmable logic controller, etc.) in communication (e.g., wired or wireless) with the computing device 120. The computing device 120 can include electronic hardware to perform the processes described herein, which can at least include electronic processor(s), memory, controller(s), wireless communication interface(s), and/or user interface(s), such as a screen, touch screen, buttons, toggles, dials, switches, etc. In some embodiments, the juicing machine 100 can be controlled and/or monitored by an operator by way of an application on a portable electronic device.

The various components of the juicing machine 100 can be manufactured using a variety of techniques. For example, certain components can be made by injection molding, additive manufacturing (e.g., 3D printing), machining, and/or other manufacturing processes. The various components described herein can be made from a variety of materials, which can at least include polymers, such as plastic (e.g., polypropylene, high density polyethylene, etc.), metal (e.g., stainless steel, aluminum, etc.), and/or metal alloys. The various components of the juicing machine 100 can be bolted together, which can permit the juicing machine 100 to be shipped separately and conveniently assembled on site, maneuvered through standard door sizes in separate components prior to assembly, and/or maneuvered without forklifts, cranes, and the like.

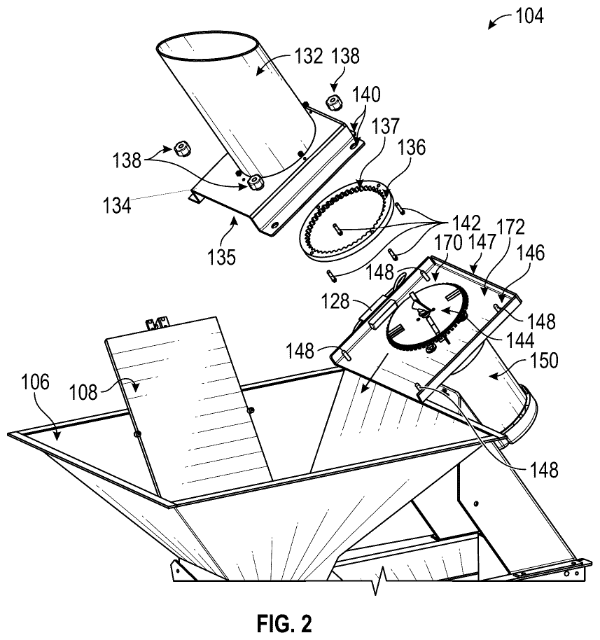

### B. GRINDER ASSEMBLY—FIGS. 2-4

FIG. 2 shows an exploded view of an example of the grinder assembly 104. The grinder assembly 104 can at least include a chute 132 (e.g., hopper, tube, receptacle), housing 134 (e.g., grinder housing, enclosure), grind ring 136 (e.g., cutting ring, ring), grinder 144 (e.g., cutter, grinder unit, cutting unit, blade, blade unit), base 146 (e.g., mount), and/or motor 150 (e.g., electric motor). More details about features of the grinder assembly 104 or features that can be incorporated into the grinder assembly 104 can be found in U.S. Pat. No. 11,844,466 and U.S. Patent Application Publication No. 2023/0218101, the entireties of which are incorporated by reference herein.

The chute 132 can receive food to be ground. The chute 132 can include a tubular or other shape. The chute 132 can be coupled (e.g., welded, fastened, bolted) to the housing 134. The chute can be positioned above the grind ring 136.

The housing 134 can be coupled to the base 146 to enclose the grinding implements, such as the grinder 144 and/or grind ring 136. The housing 134 can be disposed in a receiving region 172 (e.g., receiving space) of the base 146. The receiving region 172 can be disposed inward of a peripheral wall 147 of the base 146. The housing 134 can include flanges 140 (e.g., three flanges). The flanges 140 can be disposed on a bottom surface 170 of the base 146 such that bolts 148 extending from the bottom wall 170 extend through holes in the flanges 140 of the housing 134. Fasteners 138 (e.g., nuts) can be threaded onto the bolts 148 to fasten the housing 134 to the base 146. The housing 134 and the base 146 can cooperate to form an enclosure around the grinder 144. The housing 134 and the base 146 can cooperate to form an opening 135 through which ground food can flow into the hopper 106 as indicated by the arrow in FIG. 2.

The grind ring 136 can be an annular structure with a plurality of teeth 137. The plurality of teeth 137 can extend radially inward, which can include extending toward an axis of the grind ring 136. The plurality of teeth 137 can be disposed on a radially inward surface of the grind ring 136. The grind ring 136 can be coupled to the housing 134, which can include being fastened to the housing 134 with bolts 142. The grind ring 136 can be disposed around an outlet of the chute 132 leading into the space defined by the housing 134 and the base 146. The grind ring 136 can be disposed coaxially with the chute 132.

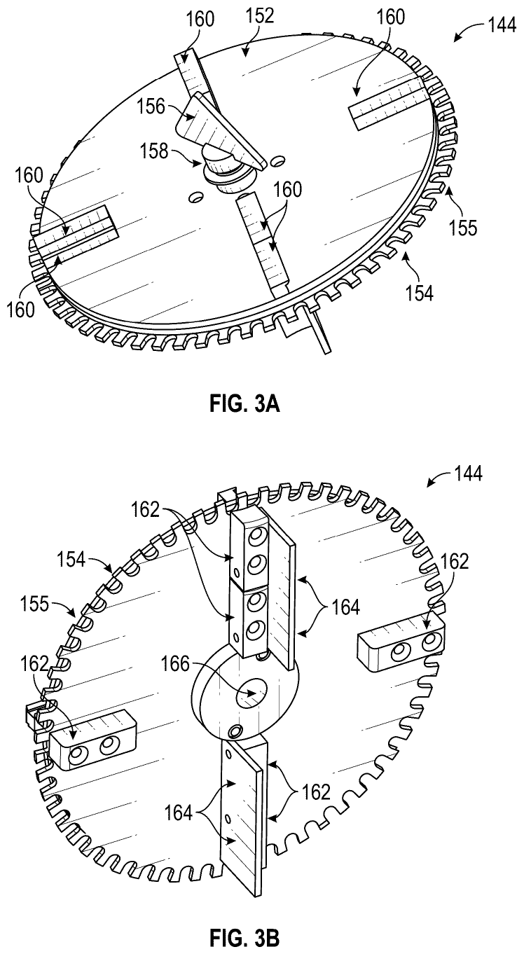

The grinder 144 can be driven (e.g., rotated) by the motor 150. The grinder 144 can rotate to grind (e.g., cut, shred) food prior to pressing. As illustrate in FIGS. 3A and 3B, the grinder 144 can include an upper portion 152 and a lower portion 154. In some embodiments, the grinder 144 has an axis of rotation that is non-horizontal and/or non-vertical.

The upper portion 152 can include an agitator 156, which can be triangle shaped. The agitator 156 can be disposed on an axis of rotation of the grinder 144. The agitator 156 can define the tallest feature of the upper portion 152. The agitator 156 can, when spinning, direct food away from a center of the grinder 144 for cutting. The agitator 156 can be disposed on a protrusion 158 (e.g., cylinder) disposed coaxially with the axis of rotation.

The upper portion 152 can include one or more loppers 160 (e.g., cutting edges, blades, wedges). The one or more loppers 160 can cut food material. The one or more loppers 160 can include an edge (e.g., cutting edge, wedge) oriented in the direction of rotation of the grinder 144. The loppers 160 can be stacked on top of each other. The loppers 160 can be disposed in series in a radial direction from the axis of rotation of the grinder. The loppers 160 can be circumferentially distributed about the axis of rotation, which can include being equidistantly spaced apart from each other (e.g., at 90, 180, 270, and 360 degrees about the axis of rotation).

The lower portion 154 can include a plurality of teeth 155. The plurality of teeth 155 can cut food. The plurality of teeth 155 can be disposed circumferentially around the lower portion 154. The plurality of teeth 155 can extend radially outward relative to the axis of rotation of the grinder 144. The plurality of teeth 155 can extend radially outward beyond a circumference of the upper portion 152.

The lower portion 154 can include one or more wipers 162. The wipers 162 can push ground food out of the grinder assembly 104 by way of the opening 135. The wipers 162 can be disposed in series in a radial direction from the axis of rotation of the grinder. The wipers 162 can be circumferentially distributed about the axis of rotation, which can include being equidistantly spaced apart from each other (e.g., at 90, 180, 270, and 360 degrees about the axis of rotation). The wipers 162 can be disposed in a mirrored arrangement relative to the loppers 160. One or more walls 164 can be coupled to one or more of the wipers 162. The one or more walls 164 can project farther from the lower portion 154 than the wipers 162. The walls 164 can provide varied height for pushing ground food.

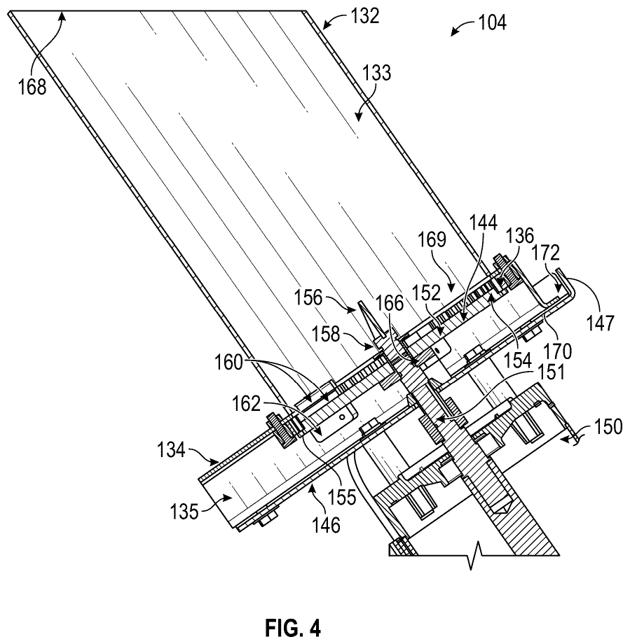

FIG. 4 illustrates a section view of the grinder assembly 104. As shown, the chute 132 can include an inlet 168, interior 133, and an outlet 169. The grind ring 136 can be disposed at the outlet 169. The grind ring 136 can be disposed coaxially with the outlet 169. The grinder 144 can be positioned such that the upper portion 152 of the grinder 144 is disposed in the grind ring 136 (e.g., radially inward of the plurality of teeth 137 of the grind ring 136) such that there is a radial gap between the upper portion 152 and the plurality of teeth 137 of the grind ring 136. The lower portion 154 can be disposed below the grind ring 136, which can include being disposed below the radial gap between the upper portion 152 and the plurality of teeth 137 of the grind ring 136.

Food can be loaded into the interior 133 of the chute 132 by way of the inlet 168. The motor 150 can rotate a shaft 151 coupled to the grinder 144 to begin grinding. The agitator 156 can direct food away from the axis of rotation of the grinder 144. The one or more loppers 160 can cut food. The rotation of the grinder 144 can throw food radially outward toward the plurality of teeth 137 of the grind ring 136, which can include being thrown into the radial gap between the upper portion 152 and the plurality of teeth 137 of the grind ring 136. The thrown food can be ground between the upper portion 152 and the plurality of teeth 137. The throw food can be ground as the food drops downward through the gap between the upper portion 152 and the plurality of teeth 137 into the plurality of teeth 155 of the lower portion 154. The ground food can drop into the space below the grinder 144, which can be the space between the housing 134 and the base 146. The one or more wipers 162 and/or walls 164 can push ground food out of the opening 135 and into the hopper 106. The base 146 can be angled such that the ground food slides along the bottom surface 170 toward the opening 135.

The safety sensor 128 can sense if the housing 134 is disposed on the base 146 to cover the grinder 144. In some embodiments, the motor 150 will not drive the rotation of the grinder 144 if the safety sensor 128 senses that the housing 134 is not positioned to cover the grinder 144. In some embodiments, the juicing machine 100 may generate a notification (e.g., visual, audible) to notify an operator that the housing 134 is not positioned to cover the grinder 144.

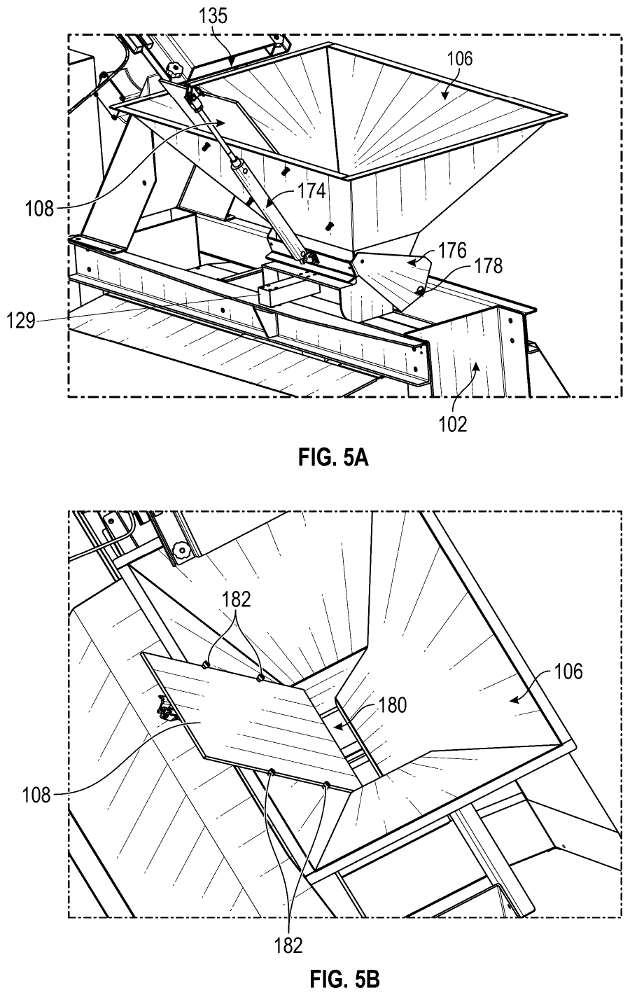

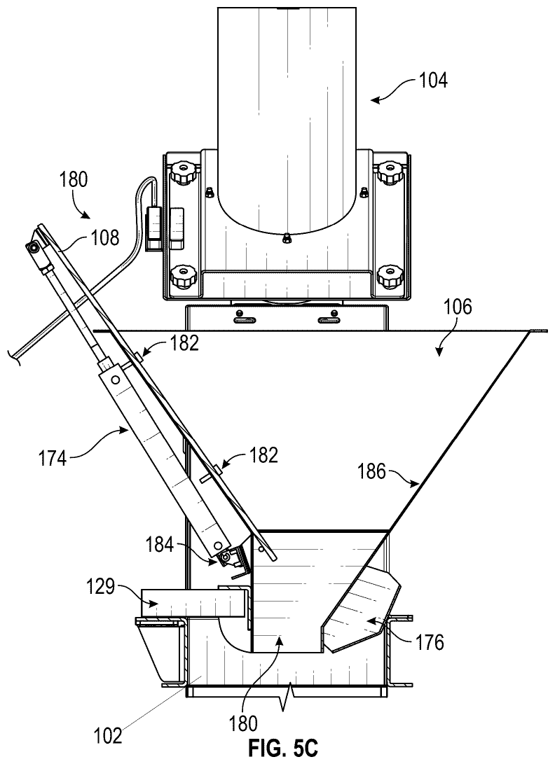

### C. HOPPER FIGS. 5A-5C

FIGS. 5A and 5B illustrate various views of the hopper 106. As described herein, the hopper 106 can include a flow controller, such as a barrier 108. The barrier 108 can be maneuvered (e.g., slid, rotated, or otherwise moved) by an actuator 174 (e.g., linear actuator, rotational actuator, electric actuator, etc.) to block or open an outlet 180 of the hopper 106. The barrier 108, when closed, can impede solids (e.g., ground food) from flowing through the outlet 180 of the hopper 106. The barrier 108 can be disposed on an angled wall of the hopper 106. The movement of the barrier 108 can be guided by one or more guides 182 (e.g., bolts), which can be coupled to the angled wall of the hopper 106. In some implementations, the guides 182 can restrict the movement of the barrier 108 to translation. In some variants, the barrier 108 is configured to rotate and may have guides for rotational movement.

The hopper 106 can include a receptacle 176 (e.g., vessel, tray, drip tray). The receptacle 176 can be rotated to a position under the outlet 180 when the barrier 108 is blocking the outlet 180. The receptacle 176 can catch juice flowing through the outlet 180 when the barrier 108 is blocking solids from flowing through the outlet 180. The caught juice can flow out of the receptacle 176 and into a conduit (e.g., tube, hose) that can direct the juice into the receptacle 116, which can allow the juice to bypass the press assembly 110. The hopper can act as a preliminary pressing and/or extraction stage, such as due to the weight of the ground food near the top of the hopper pressing some juice out of the ground food near the bottom of the hopper. The receptacle 176 can capture such juice.

FIG. 5C illustrates a section view of the hopper 106. As shown, the actuator 174 can be coupled to a top portion of the barrier 108. For example, the actuator 174 can be coupled to the top portion of the barrier 108 with a joint 185, which can permit rotation between the actuator 174 and the barrier 108. The actuator 174 can be coupled to the receptacle 176. For example, a lower portion of the actuator 174 can be coupled to a top portion of the receptacle 176 with a joint 184, which can permit rotation between the receptacle 176 and the actuator 174.

As described, the actuator 174 can move (e.g., translate) the barrier 108 to cover (e.g., close, block, obscure, etc.) the outlet 180. The barrier 108 can move from the position illustrated in FIG. 5C to contact the opposing wall 186 to block the outlet 180. When the ground food in the hopper 106 is to be pressed (e.g., a threshold quantity of ground food is sensed by the sensor 129 in the hopper 106), the actuator 174 can move (e.g., translate) the barrier 108 to uncover (e.g., open, unblock, reveal, etc.) the outlet 180 (e.g., move away from the opposing wall 186) such that the ground food in the hopper 106 can flow through the outlet 180 and out of the hopper 106. When the hopper 106 is empty, the actuator 174 can move the barrier 108 to cover (e.g., block) the outlet 180 such that the ground food from the grinder assembly 104 will accumulate in the hopper 106.

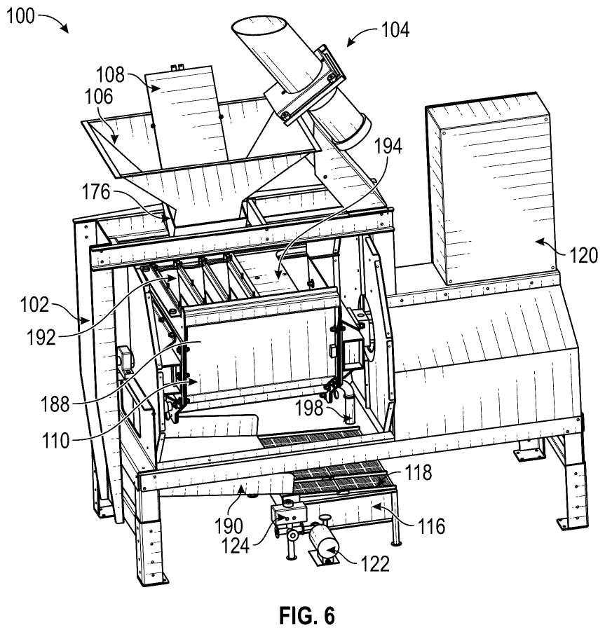

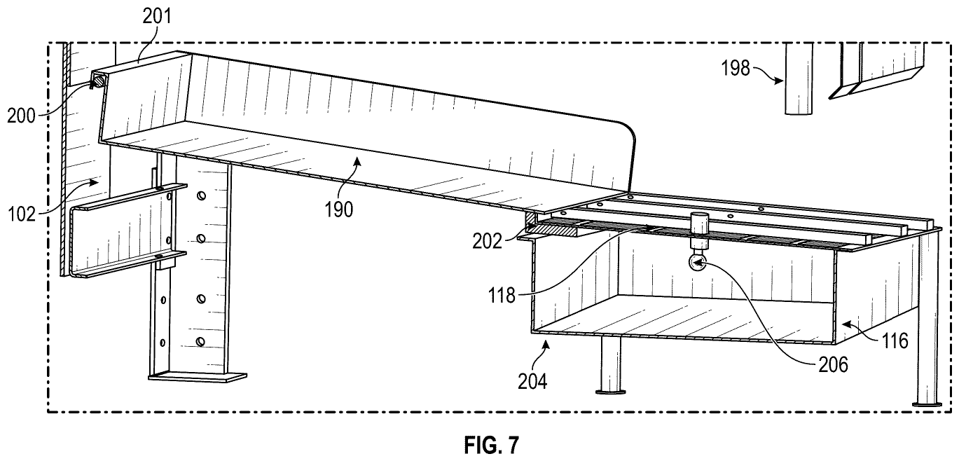

### D. RAMP AND RECEPTACLE—FIGS. 6 AND 7

The ground food can flow from the hopper 106 and into a chamber 188 (e.g., trough, receptacle, container) of the press assembly 110 through an open top 192 of the chamber 188, as illustrated in FIG. 6. The chamber 188 can be enclosed, except for the open top 192. The chamber 188 can be water-tight to contain fluid, such as juice.

As discussed in more detail below, the press assembly 110 can include a moveable platen assembly 194 (e.g., ram, press). The moveable platen assembly 194 can be advanced to press the ground food in the chamber 188 to extract juice. The extracted juice can flow out of the chamber 188 by way of an outlet 198 and into the receptacle 116. As described herein, the screen 118 can be disposed over the receptacle 116 at an angle to impede solids from flowing into the receptacle 116. The pump 122 can pump the juice from the receptacle 116.

A ramp 190 (e.g., tray, slide, pan, diverter pan) can be disposed below the press assembly 110. As described herein, the juicing machine 100 can self-clean, such as by spraying down and/or filling the chamber 188 and other components of the press assembly 110 with fluid. The press assembly 110 can be rotated to an inverted position (e.g., with the open top 192 of the chamber 188 facing downward) to dump fluid and any accompanying waste out of the chamber 188. The ramp 190 can catch the fluid and any accompanying waste. The fluid and any accompanying waste can flow down the ramp 190 to the receptacle 116. The fluid can flow through the screen 118 covering the receptacle 116. The accompanying waste, if solid, can be blocked from the interior of the receptacle 116 by the screen 118. The angle of the screen 118 can urge the solid waste to slide down the screen 118 and off an end thereof. In some embodiments, the ramp 190 can be placed under the press assembly 110 when a self-cleaning cycle is going to be performed and removed from under the press assembly 110 when juicing is being performed.

As illustrated in FIG. 7, the ramp 190 can be coupled to a feature of the frame 102 on one side and rest on the screen 118 on the other side to guide fluid and/or solids toward the receptacle 116. For example, the frame 102 can include a strut 200 (e.g., bar, rod). The ramp 190 can include a catch 201 (e.g., hook) that can interface with the strut 200 to support one side of the ramp 190. The screen 118 can include a riser 202. The riser 202 can support one side of the ramp 190 and one side of the screen 118, which can angle the screen 118.

A bottom surface 204 of the receptacle 116 can be angled to direct fluid in the receptacle 116 toward the pump 122 to ease removal of fluid. As described herein, the juicing machine 100 can include one or more conduits, fluid outlets, etc. to facilitate self-cleaning. As shown in FIG. 7, the juicing machine 100 can include a fluid outlet 206 (e.g., nozzle, sprayer, spray ball) at the receptacle 116, which can include being in the receptacle 116. The fluid outlet 206 can direct fluid into the receptacle 116 to clean an interior thereof.

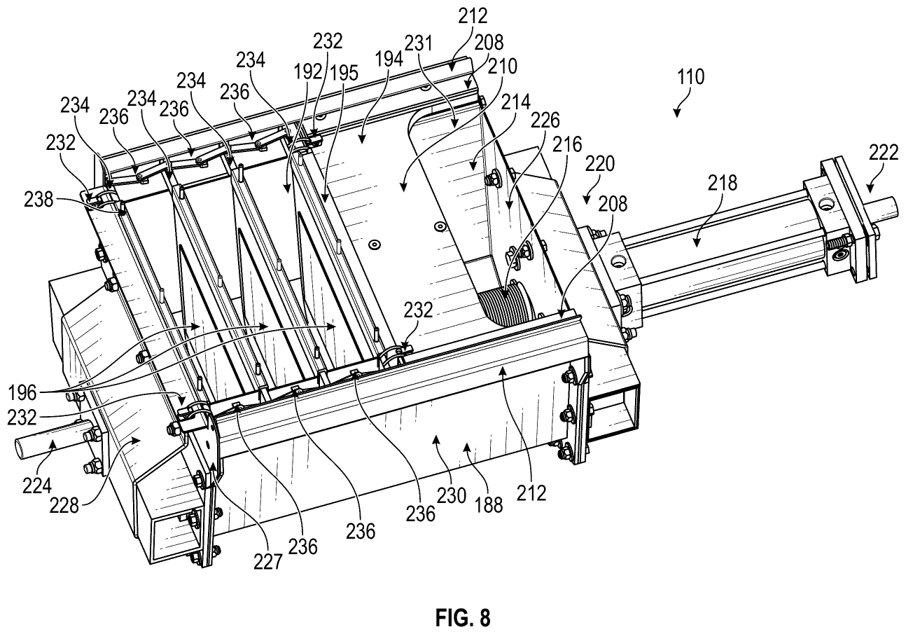

### E. PRESS ASSEMBLY—FIGS. 8-18

FIG. 8 illustrates an example of the press assembly 110. The press assembly 110 can be adapted to produce cold-press juice. For example, in several embodiments, the press assembly 110 can produce juice without needing to heat the food being juiced. The press assembly 110 can include the chamber 188, which can be water-tight. The chamber 188 can include a side wall 230, side wall 231, end wall 226, end wall 227, and an open top 192. The side walls 230, 231 can extend between the end walls 226, 227. The side walls 230, 231 can include channels 212 to orient (e.g., maintain upright) components as they translate in the chamber 188. As discussed in more detail below, the press assembly 110 can include a plurality of vertical racks and/or bags.

The press assembly 110 can include the moveable platen assembly 194. The moveable platen assembly 194 can include a moveable platen 195 (e.g., platen, movable wall). The moveable platen 195 can be disposed in the chamber 188.

The moveable platen assembly 194 can include a press shaft 216 (e.g., piston). The press shaft 216 can be coupled to the moveable platen 195 such that advancement of the press shaft 216 advances the moveable platen 195 and retraction of the press shaft 216 retracts the moveable platen 195. The press shaft 216 can extend through the end wall 226 such that a portion of the press shaft 216 is disposed in the chamber 188 and a portion of the press shaft 216 is disposed outside the chamber 188. A portion of the press shaft 216 can be retracted into a shaft housing 218 (e.g., cylinder) and deployed therefrom. The shaft housing 218 can be disposed outside of the chamber 188. The shaft housing 218 can be coupled to an outside of the end wall 226, which can be by way of a mount 220. The press shaft 216 can be actuated by an actuator, such as a hydraulic actuator, pneumatic actuator, and/or electric actuator. FIG. 8 shows the press shaft 216 retracted to space apart the wall inserts 234 and open the bags 196, which can be a position for filling the bags 196 with ground food and/or cleaning the bags 196.

The moveable platen assembly 194 can include a drip shield 210 (e.g., panel). The drip shield 210 can be coupled to the moveable platen 195. The drip shield 210 can include a panel that is horizontally oriented with respect to the moveable platen 195 (e.g., about a ninety-degree angle between each other).

The moveable platen assembly 194 can include sliders 208 (e.g., rails, wings, guides). The sliders 208 can be disposed at lateral sides of the drip shield 210. The sliders 208 can be disposed in the channels 212 of the chamber 188, which can help to maintain the moveable platen assembly 194 in an upright position when the press shaft 216 is being actuated.

The press assembly 110 can include a plurality of wall inserts 234 (e.g., walls, panels, plates, racks) that can be disposed in the chamber 188. Adjacent wall inserts 234 of the plurality of wall inserts 234 can be coupled together by way of linkages 236 (e.g., rotatably coupled struts), which can include one link of a linkage 236 being rotatably coupled to one of the adjacent wall inserts 234, the other link of the linkage 236 being coupled to the other of the adjacent wall inserts 234, and the links of the linkage 236 being rotatably coupled together. The linkages 236 can set the maximum amount of separation between adjacent wall inserts 234, which can facilitate retraction of the press shaft 216 pulling (e.g., spacing) the wall inserts 234 apart. The wall insert 234 adjacent the moveable platen 195 can be coupled to the moveable platen 195, which can be by way of fasteners 232 (e.g., clamp, latch, clasp). The wall insert 234 adjacent the end wall 227 of the chamber 188 can be coupled to the end wall 227, which can be by way of the fasteners 232.

The press assembly 110 can include a plurality of bags 196 (e.g., flexible receptacles). In some embodiments, the press assembly 110 can include one, two, three, four, five, ten, or more bags 196. The bags 196 can be disposed between and coupled to adjacent wall inserts 234. The bags 196 can be coupled to pins 238 (e.g., protrusions, rods) extending from the wall inserts 234. For example, the pins 238 can extend vertically from the wall inserts 234. The bags 196 can include holes through which the pins 238 can extend to facilitate coupling. The wall inserts 234 can include two, three, four, or more pins 238.

In various embodiments, the press assembly 110 can be rotated. For example, the press assembly 110 can be rotated to dump waste material during juicing, dump fluid during self-cleaning, and/or facilitate spraying an interior of the chamber 188, such as the bags 196 and/or wall inserts 234. The chamber 188 can be supported by a shaft 224 and a shaft 222 for rotation. The shaft 224 can be coupled to the end wall 227 by way of a mount 228. The shaft 222 can be coupled to the shaft housing 218, which can be coupled to the end wall 226 by way of a mount 220. The axis of rotation of the press assembly 110 can be generally horizontal.

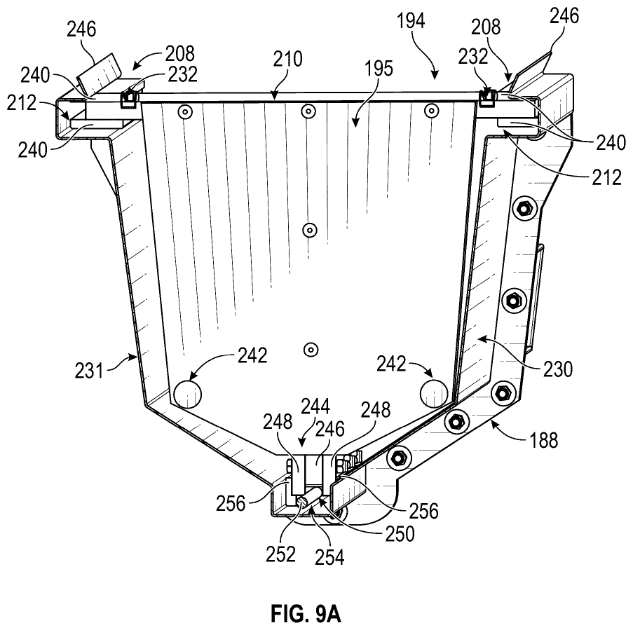

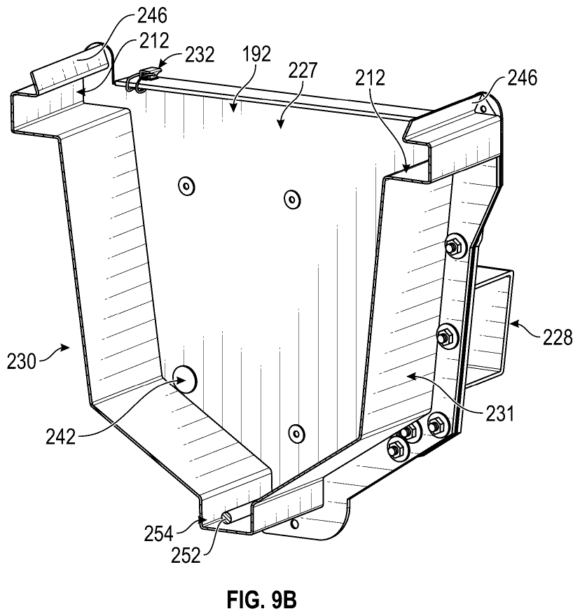

FIG. 9A illustrates a section view of the press assembly 110. As illustrated, the chamber 188 can be generally shield shaped. For example, the side walls 230, 231 can be angled inward, which can include angling inward at different angles. The side walls 230, 231 can taper inward, which can include tapering inward at different rates.

The side walls 230, 231 can extend down to a channel 254. Fluid, such as juice, can flow down the side walls 230, 231 and into the channel 254. The channel 254 can receive a foot 244 (e.g., nose, guide, rail, slider) of the moveable platen assembly 194. The foot 244 can translate within the channel 254, which can help the moveable platen 195 translate in the channel 254 without pivoting under load. The foot 244 can include a bottom portion of a flange 246 (e.g., vertical wall). The flange 246 can extend vertically down from a bottom of the drip shield 210 and along a back surface of the moveable platen 195. The flange 246 can be arranged generally perpendicularly relative to the moveable platen 195. The bottom portion of the flange 246 can extend below a lower edge of the moveable platen 195. The foot 244 can include panels 248 (e.g., flanges, plates). The panels 248 can be coupled to opposing sides of the bottom portion of the flange 246. The panels 248 can extend below a lower edge of the flange 246. The foot 244 can include guides 256 (e.g., bars, inserts). The guides 256 can be coupled to opposing sides of the panels 248. The guides 256 can extend below and around a lower edge of the panels 248. The guides 256 can contact walls forming the channel 254, which can help limit the movement of the moveable platen 195 to translational within the chamber 188. The foot 244 can include a gap 250. The gap 250 can be disposed between the panels 248 and/or guides 256. The gap 250, in some embodiments, can permit the flow of fluid, such as juice, in the channel 254 through the foot 244.

The press assembly 110 can include a rod 252 (e.g., shaft, bar) that can extend through the channel 254. The foot 244 can pass over the rod 252 with the rod 252 positioned in the gap 250. The rod 252, as described herein, can couple to the wall inserts 234 and/or bags 196, which can help secure the wall inserts 234 and/or bag 196 within the chamber 188.

As shown, the sliders 208 of the moveable platen assembly 194 can include guides 240 (e.g., panels, guides). The guides 240 can be coupled (e.g., bolted) to portions of the drip shield 210 that extend into the channel 212. In some embodiments, the guides 240 can extend beyond the lateral edges of the drip shield 210, which can include forming a gap between the guides 240 disposed in the channel 212. The guides 240 can contact the walls forming the channel 212. As described herein, the sliders 208 may translate (e.g., slide) within the channel 212 as the moveable platen assembly 194 is advanced and retracted.

The chamber 188 can include a flange 246. The flange 246 can extend vertically from the channel 212. The flange 246 can extend at an angle vertically from the channel 212. The flange 246 can form a bend in the chamber 188 to extend vertically at an angle from the channel 212.

The moveable platen 195 can include features to couple to an adjacent wall insert 234. For example, the moveable platen 195 can include pins 242 (e.g., retainers, bolts). The pins 242 can project from a face of the moveable platen 195 that contacts the adjacent wall insert 234. The adjacent wall insert 234 can include notches that can be disposed around the pins 242 to help secure the adjacent wall insert 234 (e.g., bottom portion of the adjacent wall insert 234) to the moveable platen 195.

FIG. 9B illustrates a section view of the press assembly 110. As shown, the end wall 227 of the chamber 188 can include features to couple to an adjacent wall insert 234. For example, the end wall 227 can include pins 242 (e.g., retainers, bolts). The pins 242 can project from a face of the end wall 227 that contacts the adjacent wall insert 234. The adjacent wall insert 234 can include notches that can be disposed around the pins 242 to help secure the adjacent wall insert 234 (e.g., bottom portion of the adjacent wall insert 234) to the end wall 227.

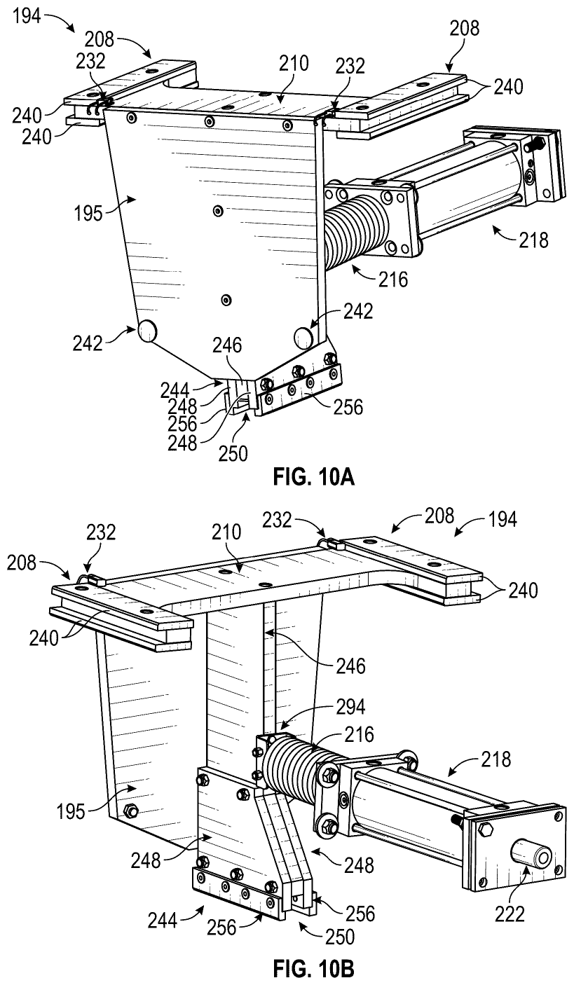

FIGS. 10A and 10B illustrate the moveable platen assembly 194 disposed outside the chamber 188. As shown, a head 294 (e.g., tip, end) of the press shaft 216 can be coupled to the moveable platen 195. For example, the head 294 can be coupled to the flange 246, which is coupled to the moveable platen 195. The head 294 can be coupled to the flange 246 by way of one or more fasteners, such as bolts.

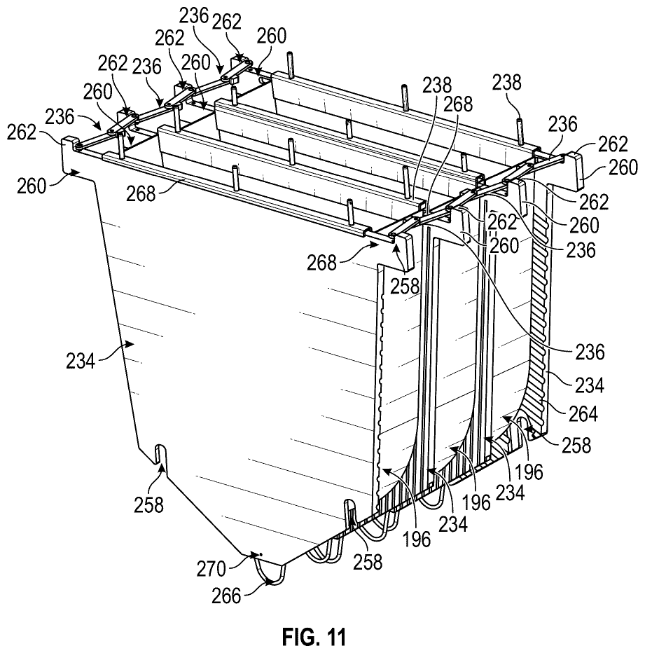

FIG. 11 illustrates the wall inserts 234 and bags 196 disposed outside of the chamber 188. As shown, in some embodiments, the press assembly 110 can include four wall inserts 234 and three bags 196. The bags 196 can be disposed between adjacent wall inserts 234. The shapes of the wall inserts 234 and/or bags 196 can be complimentary to that of the chamber 188. For example, the wall inserts 234 can have a generally shield shape, as shown.

The wall inserts 234 can include ears 260 (e.g., flanges, projections). The ears 260 can extend laterally from the wall inserts 234, which can include from a top portion thereof. The ears 260 can be disposed on opposing sides of the wall inserts 234. The ears 260 can be disposed in the channels 212 of the chamber 188, which can help the wall inserts 234 translate in an upright position in the chamber 188 as the press shaft 216 is advanced or retracted. The ears 260 can, in some embodiments, include guides 262 (e.g., projections, tabs). The guides 262 can be disposed in corresponding grooves in the channels 212 to help maintain the orientation of the wall inserts 234 during translation.

The wall inserts 234 disposed adjacent the moveable platen 195 and/or end wall 227 can be coupled to the moveable platen 195 and/or end wall 227. In some embodiments, the wall inserts 234 disposed adjacent the moveable platen 195 and/or end wall 227 can include notches 258 (e.g., cutouts, grooves, gaps). The notches 258 can be disposed over the pins 242 of the moveable platen 195 and/or end wall 227 to couple the adjacent wall inserts 234 to the moveable platen 195 and/or end wall 227.

The wall inserts 234 can include grooves 264 disposed on faces of the wall inserts 234 that contact the bags 196 and/or juice. The grooves 264 can be arranged to direct the flow of juice and/or fluid on the faces of the wall inserts 234.

The bags 196 can be disposed between adjacent wall inserts 234. The bags 196 can be coupled to the wall inserts 234. The top portions (e.g., inlets) of the bags 196 can be coupled to the top portions of the wall inserts 234 and/or the bottom portion of the bags 196 can be coupled to the bottom portions of the wall inserts 234. The bags 196 can be coupled to the pins 238 of the wall inserts 234. For example, inlets of the bags 196 can be coupled to the pins 238.

The bags 196 can have sleeves 268 disposed at inlets into the bags 196. The sleeves 268 can extend along the longitudinal side walls of the bags 196. The sleeves 268 can receive bars (e.g., struts, stiffeners) therein. The sleeves 268 and/or bars therein can include holes through which the pins 238 can be disposed to couple top portions (e.g., inlets) of the bags 196 to the wall inserts 234. In some embodiments, a lower portion of the bags 196 can be coupled to the wall inserts 234. For example, the wall inserts 234 can include coupling locations 270, which can include fasteners such as snaps, to couple to corresponding coupling locations on the bags 196.

The bags 196 can include rings 266 (e.g., loops, D ring). The rings 266 can be disposed at a lower portion of the bags 196. The rings 266 can be disposed around the rod 252 extending through the chamber 188 to secure the bags 196 and/or wall inserts 234 coupled to the bags 196 within the chamber 188.

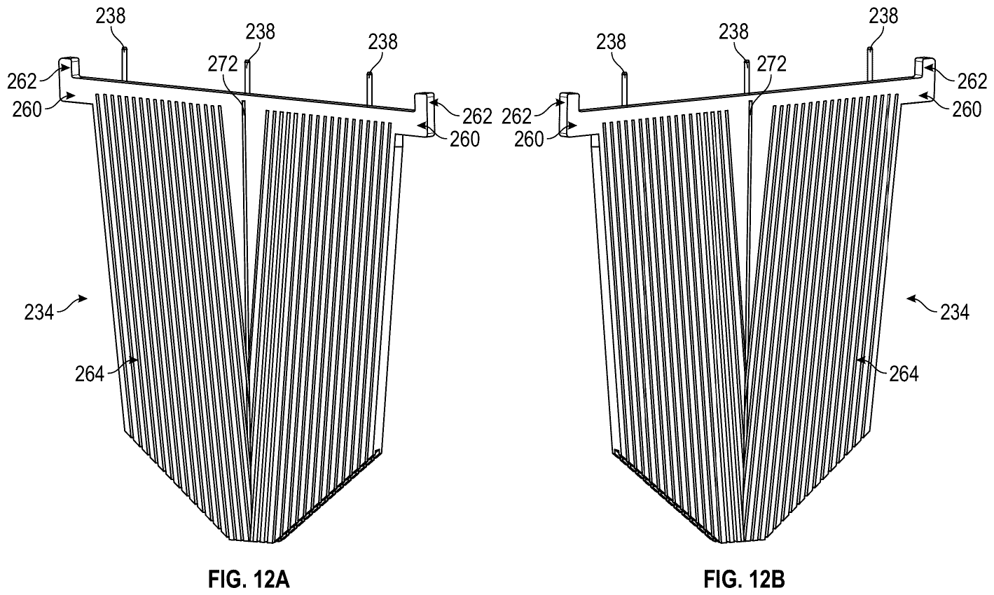

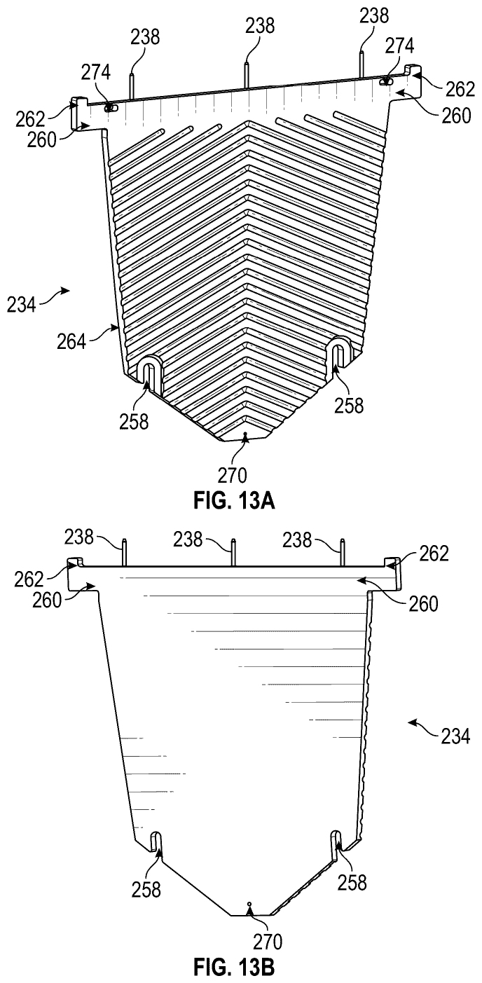

FIGS. 12A and 12B illustrate example wall inserts 234, which can be intermediary wall inserts 234 that are not disposed adjacent the moveable platen 195 or end wall 227. Both faces of the intermediary wall inserts 234 can include grooves 264, which can be disposed at an angled arrangement. The grooves 264 can be angled to direct fluid, such as juice, flowing on the faces of the intermediary wall inserts 234 toward a central groove 272 that can be oriented straight up and down. The intermediary wall inserts 234 can include coupling features, such as fasteners (e.g., snaps), to couple the intermediary wall inserts 234 to the adjacent bags 196.

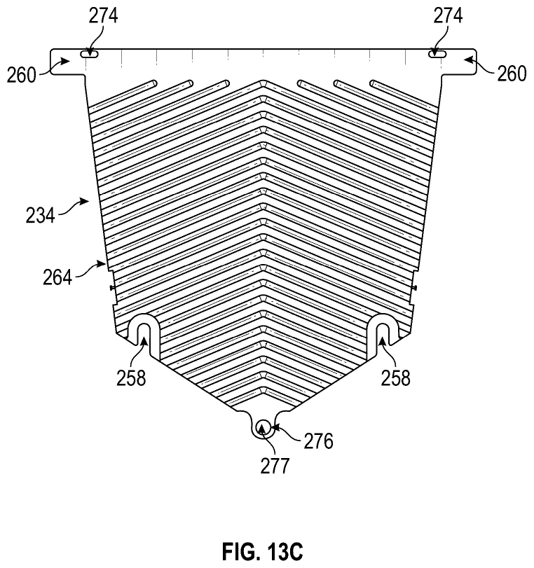

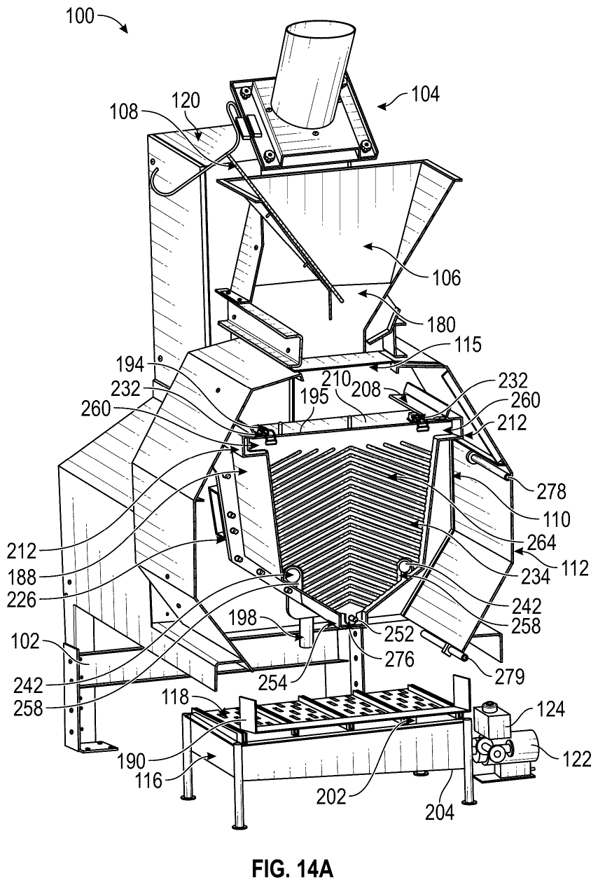

FIGS. 13A and 13B illustrate example wall inserts 234, which can be end wall inserts 234 that can be coupled to the moveable platen 195 or end wall 227. As described, the end wall inserts 234 can include notches 258 to position (e.g., slide) around the pins 242 of the moveable platen 195 and/or end wall 227. The notches 258 (e.g., two notches 258) can be disposed in a mirrored arrangement relative to a midplane of the end wall inserts 234.

The end wall inserts 234 can include grooves 264 that are angled downward and outward to lateral sides of the wall inserts 234. For example, the grooves 264 can be arranged in an inverted V shape. In some embodiments, the face of the end wall inserts 234 that will face the bags 196 (e.g., face ground material for pressing) can include grooves 264 while the face that does not face the adjacent bag 196 (e.g., face that is oriented toward the moveable platen 195 or end wall 227) does not have grooves 264.

The end wall inserts 234 can include recesses 274 to facilitate coupling to the moveable platen 195 or end wall 227 with fasteners 232. A portion of the fasteners 232 can be disposed in the recess 274, which can help secure the portion of the fasteners 232 to the end wall inserts 234. In some embodiments, as described herein, the end wall inserts 234 can include coupling locations 270 that can include fasteners such as snaps to couple to adjacent bags 196.

In some embodiments, the wall inserts 234, which can include intermediary and/or end wall inserts 234, can include a feature to couple with the rod 252 disposed in the chamber 188 to help maintain the wall inserts 234 in the chamber 188. The wall inserts 234 can include a nose 276 disposed at a bottom portion of the wall inserts 234. The nose 276 can include a recess or hole 277 through which the rod 252 can extend, as illustrated in FIG. 13C.

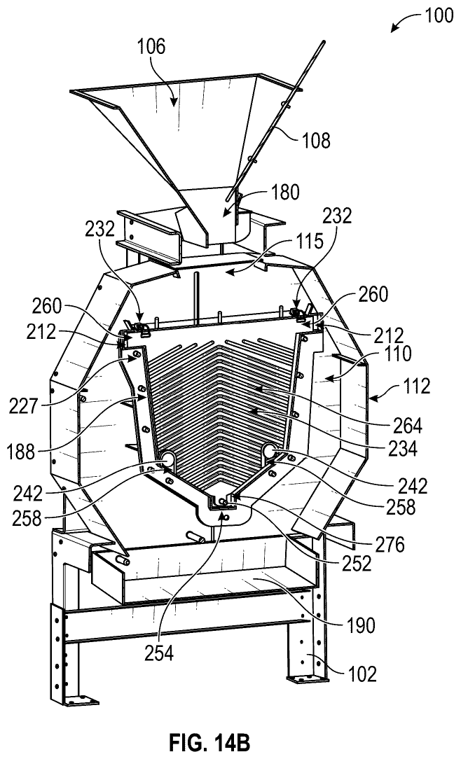

FIG. 14A illustrates a sectioned view of the juicing machine 100 with an end wall insert 234 coupled to the moveable platen 195. As shown, the fasteners 232 can couple a top portion of the end wall insert 234 to the moveable platen 195, which can include disposing portions of the fasteners 232 in the recesses 274 of the end wall insert 234. The notches 258 of the end wall insert 234 can be disposed around pins 242 of the moveable platen 195 to couple a bottom portion of the end wall insert 234 to the moveable platen 195. The rod 252 can be positioned through the nose 276 of the end wall insert 234 disposed in the channel 254 of the chamber 188, as described herein.

FIG. 14B illustrates a sectioned view of the juicing machine 100 with an end wall insert 234 coupled to the end wall 227. As shown, the fasteners 232 can couple a top portion of the end wall insert 234 to the end wall 227, which can include disposing portions of the fasteners 232 in the recesses 274 of the end wall insert 234. The notches 258 of the end wall insert 234 can be disposed around pins 242 of the end wall 227 to couple a bottom portion of the end wall insert 234 to the end wall 227. The rod 252 can be positioned through the nose 276 of the end wall insert 234 disposed in the channel 254 of the chamber 188, as described herein.

The juicing machine 100 can include one or more fluid outlets (e.g., nozzles, sprayers, spouts, conduits) to deliver a fluid to clean one or more features of the juicing machine 100, such as the chamber 188, wall inserts 234, and/or bags 196. Returning to FIG. 14A, the juicing machine 100 can include a fluid outlet 278 (e.g., nozzle, sprayer, spout, conduit) and/or fluid outlet 279 (e.g., nozzle, sprayer, spout, conduit). The fluid outlets 278, 279 can be oriented to direct fluid at the chamber 188. For example, the fluid outlets 278, 279 can be oriented to spray inside the chamber 188, which can include the wall inserts 234 and/or bags 196, as the press assembly 110 is rotated (e.g., from an inverted state toward an upright state). The fluid outlets 278, 279 can be disposed inside the enclosure 112, which can include being coupled to an inner surface of the enclosure 112. The fluid outlet 278 can be positioned higher than the fluid outlet 279 to direct fluid into the chamber 188 at different rotational positions.

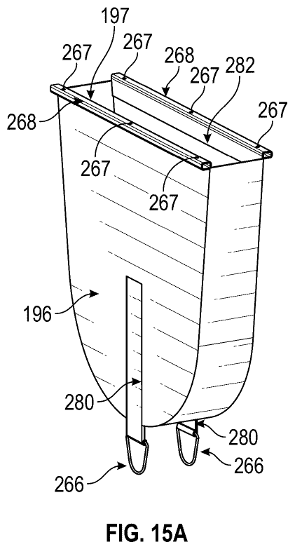

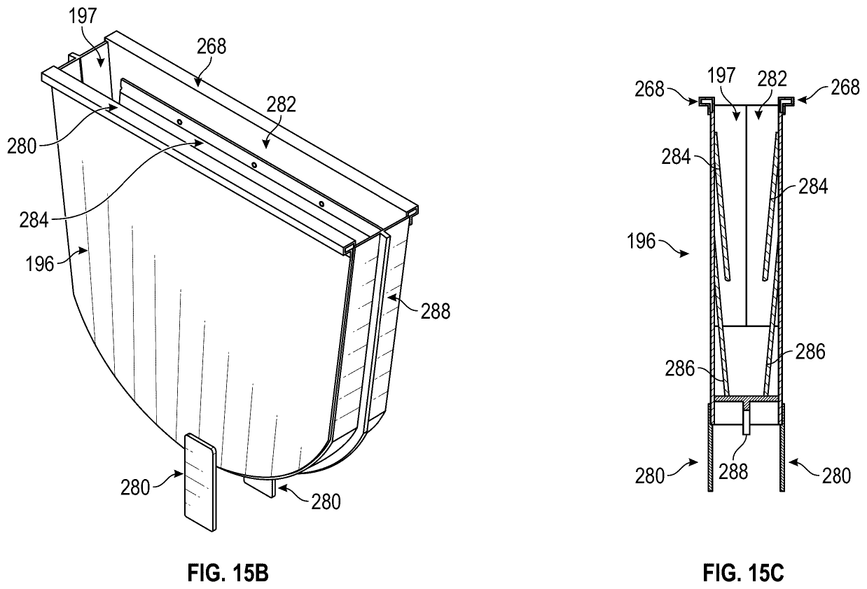

FIGS. 15A-15C illustrate various views of a bags 196. The bags 196 can include an inlet 197 (e.g., opening, upper opening). The inlet 197 can be rectangular in shape, which can correspond to the rectangular shape formed by the adjacent wall inserts 234 and side walls 230, 231 of the chamber 188. The cross-sectional size of the bags 196 can become smaller toward the bottom portion of the bags 196, which can help reduce the likelihood that food solids will remain in the bags 196 during dumping by way of rotation of the press assembly 110. The side walls 230, 231 of the chamber 188 can maintain the bags 196 between adjacent wall inserts 234 during a pressing cycle. As shown, the bags 196 can have an interior 282.

As described herein, the bags 196 can include sleeves 268 that can receive bars therein. The sleeves 268 and/or bars can include holes 267 through which the pins 238 of the wall inserts 234 can extend to couple the inlets 197 of the bags 196 to the adjacent wall inserts 234.

As illustrated in FIG. 15A, the rings 266 of the bags 196 described herein can be coupled to the bags 196 by way of a strap 280, which can be enable the rings 266 to be positioned lower than a bottom portion of the bag. As illustrated in FIG. 15B, the bags 196 can omit the rings 266 in some embodiments. The straps 280 of the bags 196 can include coupling features, such as fasteners (e.g., snaps), to couple the bottom portion of the bags 196 to bottom portions of the adjacent wall inserts 234.

As illustrated in FIG. 15B, the bags 196 can include one or more flaps, which can be disposed inside the bags 196. The flaps can enable waste material (e.g., cakes) remaining after a pressing cycle to peel away (e.g., gradually peel away) from the bags 196 with the press assembly 110 inverted. This peeling away can facilitate easier separation between the bags 196 and the waste material compared to bags 196 without internal flaps. The bags 196 can include upper flaps 284 and/or lower flaps 286, which can hang on interior walls of the bags 196.

As illustrated in FIG. 15B, the bags 196 can include a hem 288 that can couple two halves of the bags 196. The bags 196 can include a rounded bottom portion. The bags 196 can be shaped to have a rectangular cross-section.

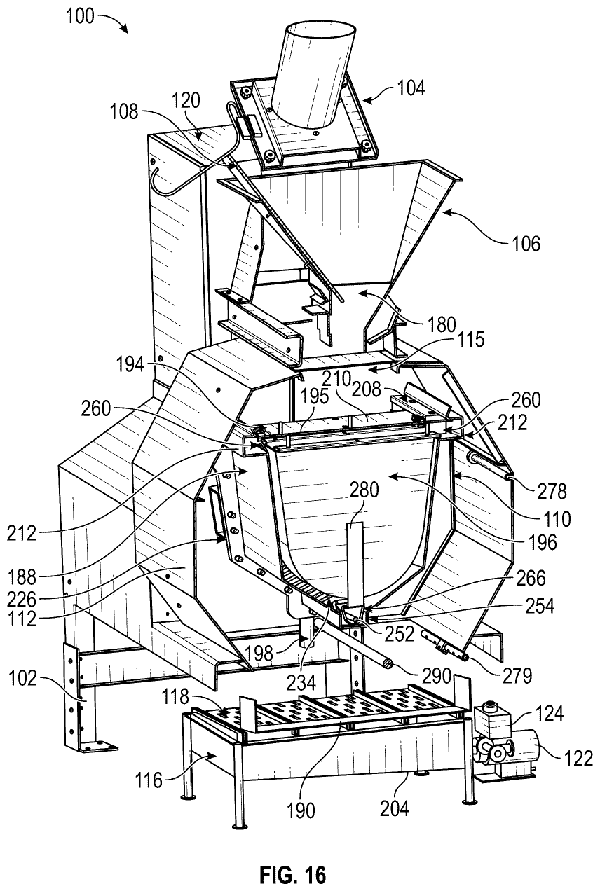

FIG. 16 illustrates a section view of the juicing machine 100 showing a bag 196 disposed in the chamber 188 of the press assembly 110. As shown, the rings 266 of the bags 196 can be disposed in the channel 254 of the chamber 188 such that the rod 252 can be disposed through the rings 266. The shape of the bag 196, as shown, can be complimentary to that of the chamber 188.

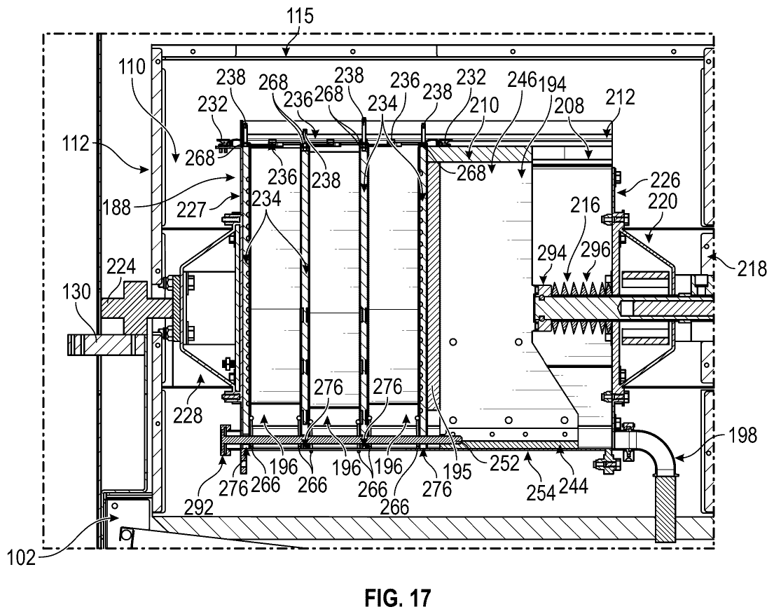

FIG. 17 illustrates a section view of at least a portion of the press assembly 110. As shown, the rod 252 can extend through the end wall 227 of the chamber 188 and into the channel 254 of the chamber 188. The rod 252 can pass through the noses 276 of the wall inserts 234 and/or rings 266 of the bags 196, which can, for example, aid in securing the wall inserts 234 and/or bags 196 within the chamber 188. In some embodiments, the bags 196 can be coupled to the rod 252 and the bags 196 coupled to the wall inserts 234 instead of, for example, directly coupling the wall inserts 234 to the rod 252. In some embodiments, the wall inserts 234 can be coupled to the rod 252 and the wall inserts 234 coupled to the bags 196 instead of, for example, directly coupling the bags 196 to the rod 252.

To remove the wall inserts 234 and/or bags 196 from the chamber 188, the rod 252 can be retracted (e.g., removed) out of the noses 276 and/or rings 266, which can include removing and/or loosening a fastener 292 (e.g., clamp, tri-clamp) securing the rod 252 in the illustrated position. The fasteners 232 can be manipulated to release the end wall inserts 234. With the rod 252 retracted and the fasteners 292 released, the wall inserts 234 can be pushed together, collapsing the linkages 236. With the wall inserts 234 pushed together, the wall inserts 234 with the bags 196 therebetween can be rotated to move the ears 260 out of the channels 212 of the chamber 188 and the wall inserts 234 and bags 196 can be lifted out of the open top 192 of the chamber 188. In some embodiments, the bags 196 can be decoupled from the rod 252 and/or wall inserts 234 and then dumped (e.g., fall by gravity) from the chamber 188 by the juicing machine 100 inverting the chamber 188. Thus, the bags 196 can be unloaded from the chamber 188 as a batch, such as by a plurality or all of the bags 196 being unloaded concurrently. The bags 196 can be unloaded as part of an automated process performed by the press machine. In some embodiments, the bags 196 can be unloaded from the chamber 188 by falling downward, without being lifted out of the chamber 188, and/or without a human needing to grasp the bags 196.

To place the wall inserts 234 and bags 196 in the chamber 188, the bags 196 can be disposed between the wall inserts 234 and coupled thereto as described herein. The rod 252 can be retracted (e.g., removed). The wall inserts 234 can be pushed together, collapsing the linkages 236, with the bags 196 between the wall inserts 234. With the wall inserts 234 pushed together, the wall inserts 234 and bags 196 therebetween can be disposed inside the chamber 188. The wall inserts 234 and bags 196 can be rotated within the chamber 188 to position the ears 260 of the wall inserts 234 inside the channels 212 of the chamber 188. The end wall inserts 234 can be coupled to the end wall 227 and moveable platen 195 as described herein. The rod 252 can be advanced through the noses 276 of the wall inserts 234 and rings 266 to secure the wall inserts 234 and bags 196 as shown in FIG. 17.

As described herein, the head 294 of the press shaft 216 can be coupled to the moveable platen 195, which can be by way of the flange 246. Advancement of the moveable platen 195 can cause the wall inserts 234 to move towards each other as the moveable platen 195 is pushed by the press shaft 216 toward the end wall 227. The retraction of the moveable platen 195 by way of retraction of the press shaft 216 can cause the wall inserts 234 to be pulled apart from each other (e.g., move away from each other, space apart from each other), which can open the bags 196. The end wall insert 234 coupled to the moveable platen 195 can pull the wall inserts 234 apart from each other by way of the linkages 236 coupling the wall inserts 234 together. The linkages 236 can expand as the wall inserts 234 are separated. The linkages 236 can set a maximum distance that the wall inserts 234 can be spaced apart from each other.

As shown in FIG. 17, the press shaft 216 can include a covering 296, which can be a bellows, sheath, or otherwise. The covering 296 can keep the press shaft 216 clean, which can improve reliability of the press assembly 110.

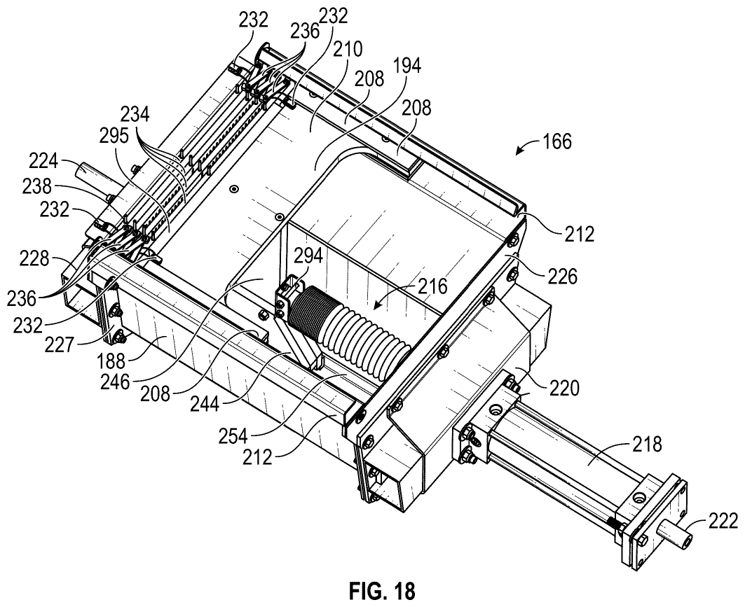

FIG. 18 illustrates the press assembly 110 with the press shaft 216 in an extended position with the moveable platen 195 advanced toward the end wall 227 of the chamber 188. As shown, the wall inserts 234 have been moved closer together with the linkages 236 collapsed, which can correspond to the configuration of the chamber 188 at the end of a press cycle (e.g., after juice has been extracted from ground food).

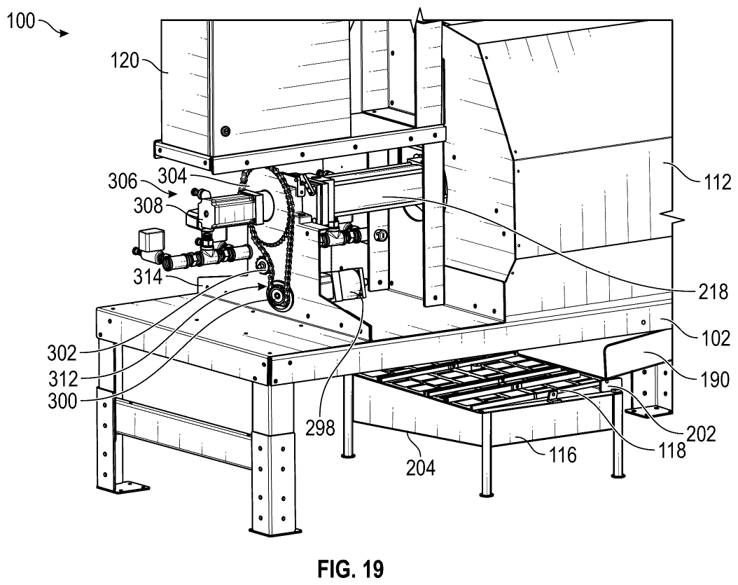

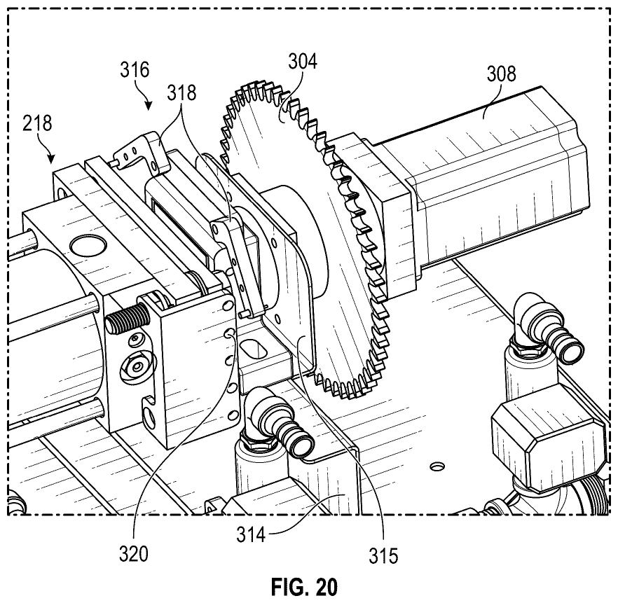

### F. ROTATION ASSEMBLY—FIGS. 19-23C

As described herein, the press assembly 110 can be rotated to different orientations to dump waste material after pressing (e.g., cakes), dump fluid for cleaning, and/or facilitate spraying components of the chamber 188 for cleaning. As illustrated in FIG. 19, the juicing machine 100 can include a rotation assembly 306 that can rotate the press assembly 110. In some embodiments, the rotation assembly 306 can rotate the press assembly 110 one hundred and eighty degrees from an upright position to an inverted position. In some embodiments, the rotation assembly 306 can rotate the press assembly 110 three hundred and sixty degrees.

The rotation assembly 306 can include a motor 298 (e.g., electric motor), which can be a step motor. A step motor, in some embodiments, can be advantageous to avoid the use of an external encoder (e.g., sensor) to monitor the rotational position of the press assembly 110. A step motor, in some embodiments, can be advantageous to avoid the use of an external braking system. The rotation assembly 306 can include a motor gear 300, idler gear 302, and/or shaft gear 304, which can be rotatably mounded on a vertical wall 314. The motor 298 can drive a motor gear 300. The motor gear 300 can drive a force transmission device, such as a chain or belt 312. The chain 312 can be disposed around the idler gear 302 and/or shaft gear 304 to drive rotation of the idler gear 302 and/or shaft gear 304. The rotation of the shaft gear 304 can drive rotation of the press assembly 110. For example, the shaft gear 304 can be coupled to the shaft 222 of the press assembly 110.

In some variants, rotation of the press assembly 110 can be directly driven by a motor 308 (e.g., electric motor). The juicing machine 100 can include a sensor system 316 to monitor the rotational position of the press assembly 110. For example, the rotation assembly 306 can include one or more sensors 318, which can be disposed on arms or other structures. The sensors 318 can be coupled to one or more flanges 315 of the vertical wall 314. The sensor system 316 can include magnets 320, which can be disposed on flanges of the press assembly 110 (e.g. flanges coupled to the shaft housing 218 of the press assembly 110). The sensors 318 and rotating magnets 320 can interact to monitor the rotational positioning of the press assembly 110. Data from the sensors 318 regarding the rotation positioning of the press assembly 110 can be communicated to the computing device 120 of the juicing machine 100. In some embodiments, the juicing machine 100 may not incorporate the sensor system 316, such as in an embodiment with a step motor driving rotation of the press assembly 110.

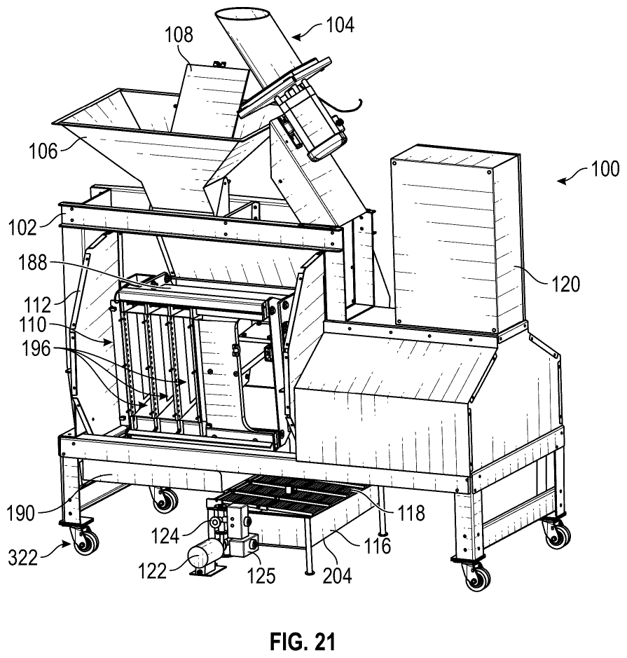

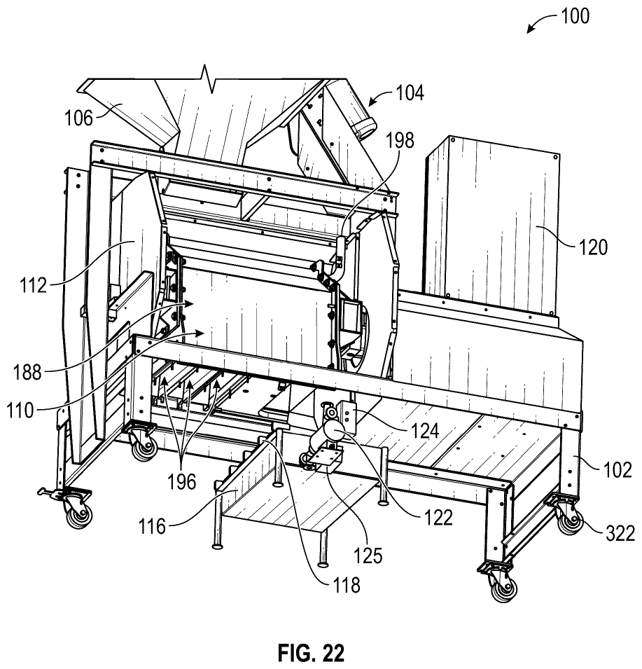

FIG. 21 illustrates the press assembly 110 rotated to an intermediary position between an upright position, as illustrated in FIG. 6, and an inverted position, as illustrated in FIG. 22. As illustrated in FIG. 21, the juicing machine 100 can be disposed on wheels 322 (e.g., caster wheels) to facilitate moving the juicing machine 100. For example, the wheels 322 can be coupled to the frame 102. FIG. 22 illustrates the juicing machine 100 rotated to the inverted position, which can be during juicing, after juicing (e.g., during a dumping operation), and/or self-cleaning.

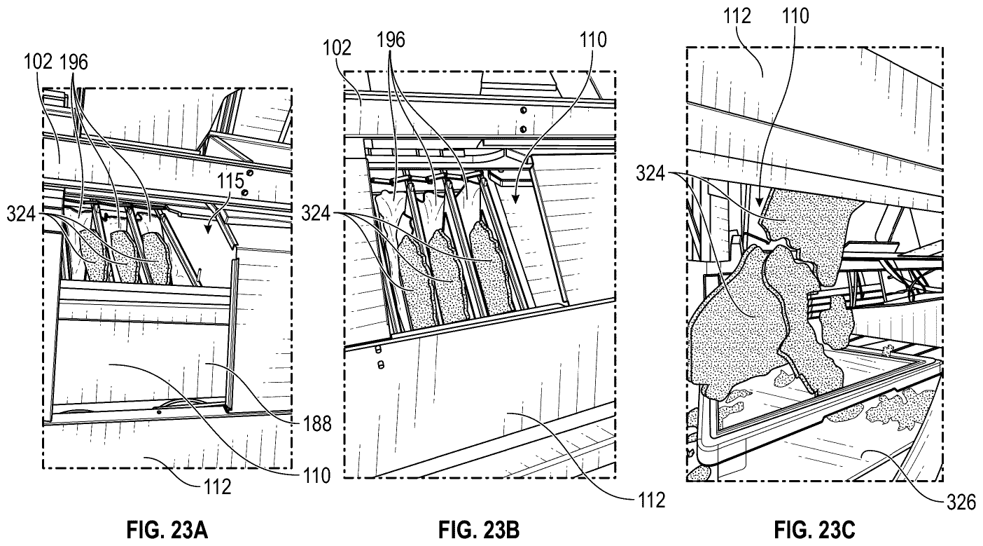

FIGS. 23A-23C illustrate the press assembly 110 being rotated to dump waste material (e.g., cakes) after pressing. As shown in FIG. 23A, after pressing, waste material 324 (e.g., cakes, dry cakes) can remain in the bags 196. The juicing machine 100 can automatically rotate the press assembly 110 to dump the cakes from the upright position illustrated in FIG. 23A to the inverted position illustrated in FIG. 23C. During rotation of the press assembly 110, or prior to rotation, the press shaft 216 can be retracted to separate the wall inserts 234 and/or open the bags 196. FIG. 23B illustrates the press assembly 110 at an intermediary rotational position between the upright and inverted positions. As shown, the bag 196 can be open, or can be in the process of being opened, when the press assembly 110 is in or passes through the intermediary rotational position. FIG. 23C illustrates the press assembly 110 in an inverted position dumping the waste material 324 into a container 326 disposed below the press assembly 110. The container 326 can be removed to discard the waste material 324. In some embodiments, a conveyor can be disposed beneath the press assembly 110 to catch and automatically convey waste material 324 away from the juicing machine 100. In some embodiments, the juicing machine 100 can spray the press assembly 110 (e.g., chamber 188, wall inserts 234, bags 196, and/or waste material 324) as the press assembly 110 is being rotated to the inverted position for dumping and/or when rotated back to the upright position for filling the bags 196 for another pressing cycle.

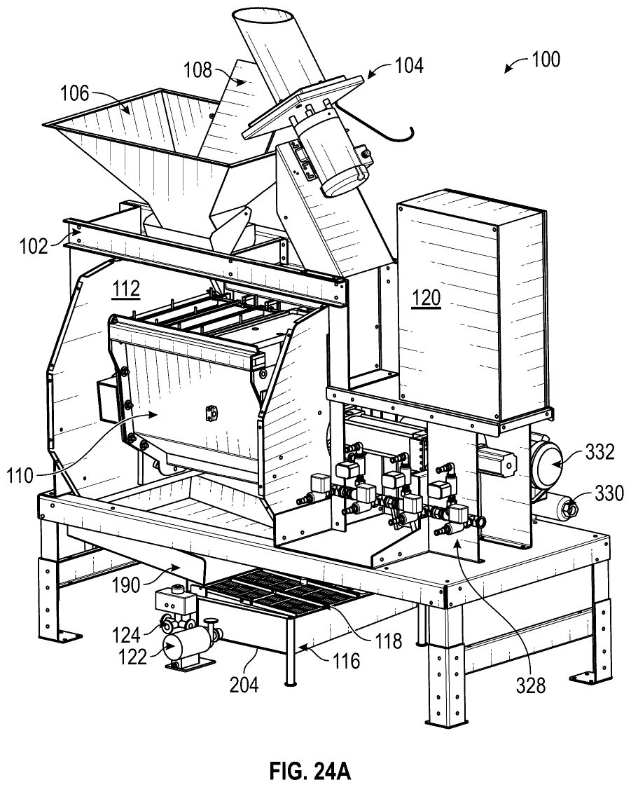

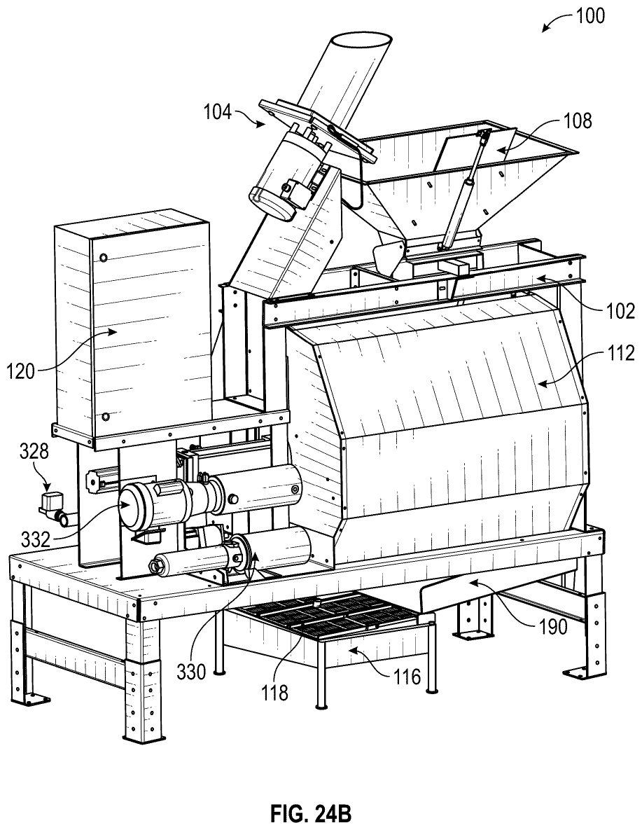

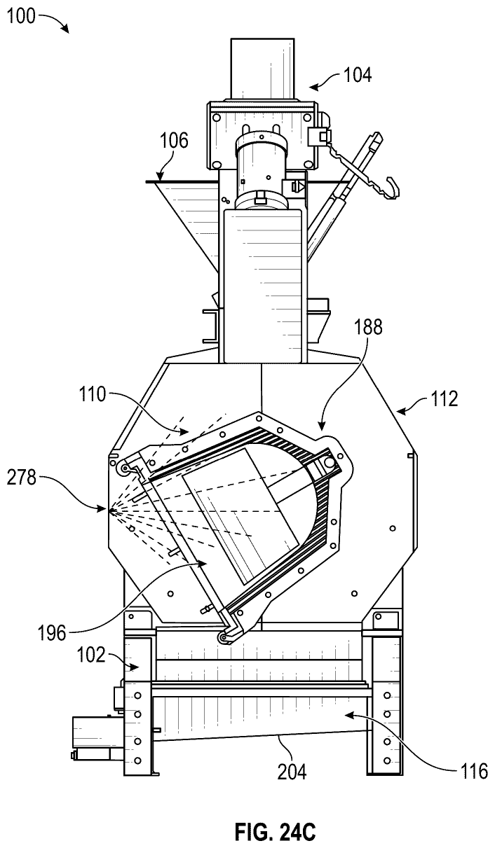

### G. SELF-CLEANING FEATURES—FIGS. 24A-26

As described herein, the juicing machine 100 can include one or more features to self-clean. As illustrated in FIGS. 24A and 24B, the juicing machine 100 can include a manifold 328 (e.g., valve system) to direct fluid, such as recirculated fluid, for cleaning the juicing machine 100. The manifold 328 can include tubing, outlets, inlets, valves, and/or pumps to direct the flow of a fluid.

The juicing machine 100 can include a pump 330 (e.g., booster pump). The pump 330 can urge recirculated fluid from the receptacle 116 to the manifold 328 to be directed for cleaning.

The juicing machine 100 can include a linear actuation system 332 (e.g., hydraulic system), which can at least include a hydraulic pump, hydraulic directional valve, and/or hydraulic cylinder to actuate the press shaft 216. In some embodiments, the juicing machine 100 can include an electric and/or pneumatic actuation system to actuate the press shaft 216.

As described herein, the juicing machine 100 can self-clean using fluid (e.g., water (e.g., hot water), solvent, cleaning agent, sanitizing agent, disinfectant), which can include recirculated fluid. Fluid can be directed out of one or more fluid outlets to clean one or more components of the juicing machine 100, which can at least include the grinder assembly 104, hopper 106, barrier 108, press assembly 110 (e.g., chamber 188, wall inserts 234, bags 196, moveable platen assembly 194, etc.), screen 118, receptacle 116, ramp 190, and/or other features of the juicing machine 100. The fluid can flow along the flow path of juice and/or food through the juicing machine 100. For example, fluid directed to the grinder assembly 104 for cleaning can flow through the grinder assembly 104, hopper 106, and chamber 188 into the receptacle 116. Fluid directed to the hopper 106 can flow through the hopper 106 to the chamber 188 and into the receptacle 116. Fluid directed to the press assembly 110 can flow out of the chamber 188 and into the receptacle 116. The fluid can flow out of the chamber 188 and into the receptacle 116 by way of the outlet 198.

The juicing machine 100 can include at least two cleaning stages. The cleaning stages clean an interior of the machine 100 and/or components therein, such as the bags 196. In some implementations, the stages include a rinse stage and a sanitizing stage. The two stages can utilize fluid to clean the components of the juicing machine 100. The fluid in the two stages can be the same (e.g., water, cleaning agent, etc.). The fluid in the two stages can be different. For example, in some embodiments, one stage can include water to rinse components of the juicing machine 100 and other stages can include an agent, such as a cleaning agent, sanitizing agent, disinfecting agent, etc., to sanitize the components of the juicing machine 100. In some implementations, at least one stage uses a caustic fluid. For example, at least one stage can use an alkaline fluid and/or at least one stage (e.g., a different stage) can use an acidic fluid. The alkaline and acid fluids can interact to negate each other (e.g., result in a substantially neutral PH). In certain embodiments, at least one stage uses a neutral fluid (e.g., water), such as for rinsing.

One cleaning stage can include spraying the components of the juicing machine 100 with fluid by way of one or more fluid outlets, such as nozzles, jets, shower heads, etc. For example, to clean the chamber 188, one or more fluid outlets (e.g., fluid outlet 278, fluid outlet 279) can spray the chamber 188 and the components therein, which can include the bags 196, wall inserts 234, and/or moveable platen 195. The chamber 188 can be rotated to different positions while the one or more fluid outlets spray fluid, which can include rotating the chamber 188 such that the one or more fluid outlets spray fluid into the bags 196, as shown in FIG. 24C. In some embodiments, the press shaft 216 can be advanced or retracted to close or open the bags 196 for spraying and/or to loosen waste in the bags 196. In some embodiments, a spraying stage can be performed with water to rinse components of the juicing machine 100.

Another cleaning stage can include filling the chamber 188 with a fluid, which can be called a filling stage. This can at least partially submerge the bags 196, wall inserts 234, moveable platen 195, and/or other components disposed in the chamber 188. For example, the outlet 198 can be closed (e.g., by way of a valve) and fluid can be introduced into the chamber 188 (e.g., by the fluid outlets) to partially or completely fill the chamber 188 with fluid. For example, one or more fluid outlets (e.g., fluid outlet 278, fluid outlet 279) of the juicing machine 100 can direct a flow (e.g., stream) of fluid into the chamber 188. As described herein, the chamber 188 can be water-tight such that the fluid fills the chamber 188, which can at least partially submerge the bags 196, wall inserts 234, moveable platen 195, and/or other features of the press assembly 110 in the chamber 188. In some embodiments, the bags 196 are submerged up to or near the sleeves 268 and/or at least a majority of the height of the bags 196 is submerged. In some embodiments, at least about: 75%, 80%, 85%, 90%, 95%, or 99% of the height of the bags 196 is submerged. In certain variants, the bags 196 are entirely submerged. In some implementations, the wall inserts 234 are submerged at least up to or near the bottom of the ears 260. The press shaft 216 can be retracted and/or advanced with the fluid in the chamber 188 to move the moveable platen 195, wall inserts 234, and/or bags 196 for cleaning, which can include agitating the fluid for cleaning. The agitation of the fluid can facilitate cleaning of the bags 196 and/or wall inserts 234. In some embodiments, the filling stage can be performed with a cleaning agent to sanitize the components of the press assembly 110 that are at least partially submerged.

In some embodiments, one or more of the stages can be repeated during a cleaning cycle. For example, a rinse stage can be followed by a submerging stage which can be followed by another rinse stage.

In certain implementations, the machine 100 periodically performs a “quick reset.” The quick reset can include at least spraying the bags 196 with water or another fluid, such as from the fluid outlets (e.g. nozzles). The quick reset can help stop food from blocking pores in the bags 196 and/or inhibit food from becoming stuck on the bags 196. In some embodiments, the machine 100 performs the quick reset between each juicing operation, or between every two, three, four, five, ten, or more juicing operations, etc. The quick reset can be performed automatically or in response to a user input command.

In some embodiments, the ramp 190 can be positioned below the press assembly 110 prior to self-cleaning. The press assembly 110 can be rotated to dump fluid and/or waste material onto the ramp 190 which can direct the dumped fluid and/or waste material to the receptacle 116. As described herein, the angled screen 118 can impede solids from flowing into the receptacle 116. The angle of the screen can cause solids to slide off the screen 118, which can inhibit or prevent build up and blocking the passage of fluid through the screen 118.

The pump 122 can pump the fluid from the receptacle 116 for recirculation. In some embodiments, a valve 125 (e.g., three-way valve), as shown in FIG. 21, can be disposed at the outlet of the receptacle 116 before the pump 122. The valve 125 can include an outlet to drain the fluid outside of the juicing machine 100. The valve 125 can direct fluid to the pump 122. The valve 124 (e.g., three-way valve) can be disposed at an outlet of the pump 122. The valve 124, during juicing, can direct juice to a container for storage. During self-cleaning, the valve 124 can direct pumped fluid to the pump 330. The pump 330 can urge the fluid back to the manifold 328 for recirculation (e.g., for spraying of one or more components of the juicing machine 100).

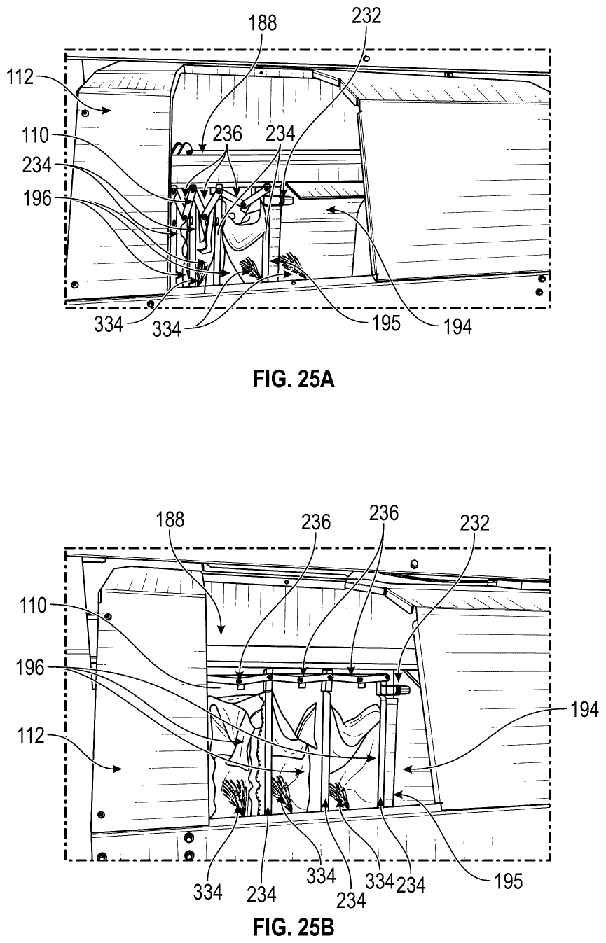

FIG. 25A illustrates the fluid outlet 278 spraying fluid, which can be recirculated fluid, at the press assembly 110 in a rotated position. As shown, the fluid outlet 278 can spray into an interior of the chamber 188, wall inserts 234, and/or bags 196 for cleaning. FIG. 25B illustrates the press shaft 216 retracting to separate the wall inserts 234 and/or open the bags 196 for cleaning with the press assembly 110 rotated to different positions. As shown, the juicing machine 100 can direct a plurality of streams (e.g., sprays) of fluid 334. For example, the one or more fluid outlets, such as the fluid outlet 278, can at least include three streams of fluid 334 that are positioned to spray into the bags 196 as shown in FIG. 25B. In some embodiments, the fluid outlets described herein can be in a fixed position or be maneuvered (e.g., spin, rotate, pivot, translate). In some embodiments, one or more nozzles are configured to spray fluid into the bags 196 in an inverted position.

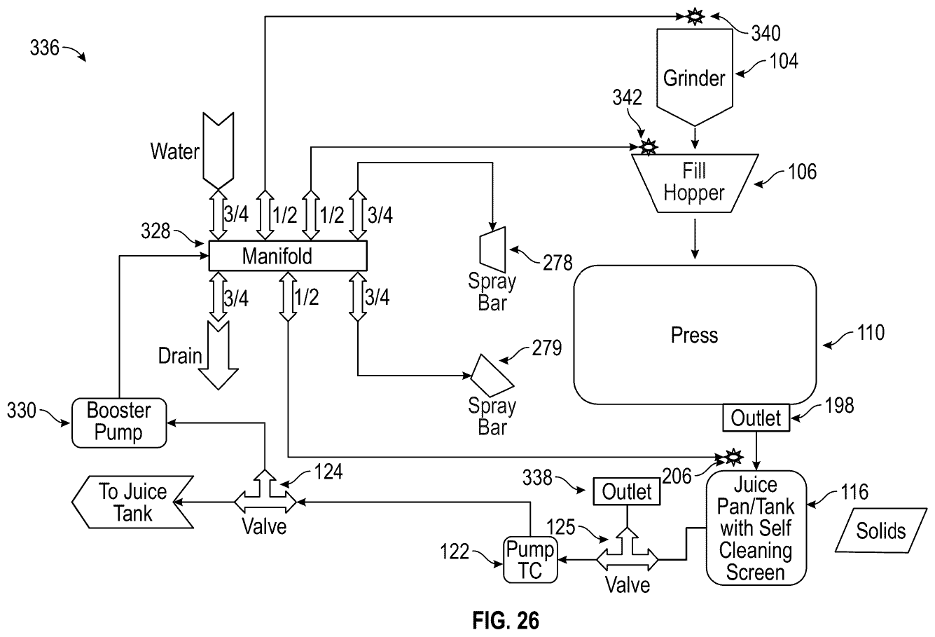

FIG. 26 illustrates a schematic of a fluid system 336 (e.g., fluid recirculation system) for self-cleaning. To begin cleaning, a fluid (e.g., water, cleaning agent, solvent, etc.) can be introduced into the manifold 328. The manifold 328 can direct fluid to various fluid outlets (e.g., nozzles, sprayers, etc.) of the juicing machine 100 for cleaning. For example, the manifold 120 can direct fluid to the fluid outlets 278, 279 for cleaning the press assembly 110 (e.g., chamber 188, wall inserts 234, and/or bags 196), a fluid outlet 340 at the grinder assembly 104, a fluid outlet 342 at the hopper 106 (e.g., fill hopper), and/or a fluid outlet 206 at the receptacle 116, and/or a fluid outlet at the ramp 190.

As described herein, the fluid can flow along the flow path of the juice and/or food. For example, the fluid directed to the grinder assembly 104 can flow into the hopper 106 and into the chamber 188 of the press assembly 110. The fluid directed to the 106 can flow into the chamber 188 of the press assembly 110. The fluid in the chamber 188 can flow out by way of the outlet 198 into the receptacle 116. Alternatively, fluid in the chamber 188 can be dumped onto the ramp 190 and into the receptacle 116 by inverting the press assembly 110 to allow fluid to be dumped out of the chamber 188 and into the ramp 190 disposed thereunder. The screen 118 can filter out solids.

The outlet 198 can be closed with a valve or another device to fill the chamber 188 for cleaning the components in the chamber 188, such as the wall inserts 234, moveable platen 195, and/or moveable platen 195. The press shaft 216 can extend or retract to move the wall inserts 234, moveable platen 195, and/or moveable platen 195 for cleaning, such as agitating the fluid. The valve can be opened to evacuate fluid by way of the outlet 198. The valve can remain closed and the fluid evacuated by inverting the press assembly 110 to dump the fluid.

The valve 125 can be disposed at the outlet of the receptacle 116 that can direct fluid to drain out or to the pump 122. The pump 122 can be fluidically coupled to the valve 124 that can direct fluid, such as juice, into a juice container or fluid, such as cleaning fluid, to the pump 330. The pump 330 can direct fluid back to the manifold 328 for recirculation. The fluid can be repeatedly recycled until cleaning is complete, which can be time based and/or based on the sensors of the juicing machine 100 indicating that cleaning is complete (e.g., amount of waste material remaining is below a threshold, no waste material is remaining, etc.). The fluid can be drained by way of an outlet on the manifold 328 and/or from the juice tank 116. The cleaning cycle can include cleaning the juicing machine 100 with different fluids in sequence, all of which can be recirculated by the components described herein. For example, the cleaning cycle can include rinsing with water, cleaning with solvent, rinsing with water, cleaning with a sanitizing agent, etc. The juicing machine 100 can include conduits, hoses, tubing, etc. to direct fluid between the various components illustrated in FIG. 26.

### H. OTHER ASPECTS

In some embodiments, a load sensor can be disposed at the receptacle 116 to measure a quantity (e.g., weight) of juice therein. Data from the load sensor can be communicated to the computing device 120 to determine juice yield.

In some embodiments, the press cycle can be performed in one to one and half minute. The press shaft 216 can retracted quickly (e.g., about 5 seconds or less). The press shaft 216 can be retracted while the press assembly 110 is being rotated. The press assembly 110 can be rotated between inverted and upright positions in about 5 seconds or less. The press assembly 110 can be rotated more slowly when spraying for cleaning (e.g., 10 to 15 seconds).

An aspect of the present technology is to improve throughput of the juicing machine, which can include shortening the length of time for one or more steps of the press cycle. For example, the grinder assembly can grind food in parallel with the press pressing ground food. Accordingly, the ground food can be ready for immediate delivery into the bags 196 when the bags 196 are emptied, opened, and with outlets thereof facing upright. In another example, the press assembly 110 can simultaneously rotate the press assembly 110 back to an upright position after dumping waste while opening the bags (e.g., retracting the piston of the press) such that the juicing machine is immediately ready for another press cycle.

Another aspect of the present technology is to use relatively smaller and/or fewer bags. For example, relatively smaller bags can reduce an opening and closing time, cleaning time, and/or filling time for the bags. Smaller bag sizes can permit smaller racks in some aspects. The press assembly 110 described herein can include relatively fewer bags (e.g., 2, 3, 4, 5), which can reduce an opening and closing time, cleaning time, installation time (e.g., coupling with wall inserts 234 and/or rod 252 in the chamber 188), and/or filling time for the bags 196. A smaller number of bags can be easier to fill substantially evenly and/or the greater the number of bags 196 the more difficult it can be to evenly fill them. The smaller and/or fewer number of bags can reduce the overall length and/or width of the juicing machine. The smaller and/or fewer number of bags can reduce the squeezing force required during a press cycle, which can enable the juicing machine to be smaller in size and/or lighter to reduce used floor space and/or ease moving the juicing machine (e.g., move the juicing machine on wheels such as casters).

The relationship between bag size and squeeze force is square, meaning that if the area of the bag doubles then the squeeze force required for a press cycle quadruples. A typical squeezing force is between 30 and 100 psi on the ground food in the bag, with about 45 psi being preferred. Accordingly, for other juicing machines that use 36 inch by 36 inch bags (e.g., 1,296 square inches), the force is 58,320 lbs. or about 30 tons (i.e., 1,296 square inches multiplied by 45 psi). In contrast, the force is 14,580 lbs. or about 7 tons for 18 inch by 18 inch bags (e.g., 324 square inches). Thus, a press machine that uses smaller bags can be significantly smaller, lighter, and/or easier to transport than a machine that uses larger bags.

A smaller bag size can provide an improved surface to volume ratio to permit a shorter pressing time (e.g., two minutes, less than two minutes) compared to larger bag sizes. There is a limit as to how food, such as ground food, can be pressed (e.g., squeezed) without the food overflowing out of the open tops of the bags. For example, when the food is pressed at a rate that is too fast, the juice cannot all exit the bag through the holes in the walls of the bag but, instead, some of the food overflows out of the open top of the bag. If the compression speed limit is not exceeded, the juice can be pressed out and leaves the bag through the holes in the walls of the bag instead of overflowing out of the open tops. With the juice pressed out, the de-juiced food material be a leftover cake that resembles a piece of plywood. The larger the surface-to-volume ratio of a bag, the faster the bag can be compressed. When the dimensions of the bags are made smaller, the surface area to volume ratio increases to permit faster compression speeds. For example, a large bag can have the dimensions 40 inches by 40 inches by 3 inches, which is 3,560 square inches in surface area and 4,800 cubic inches of volume for a surface to volume ratio of 0.742 (i.e. 3,560/4,800). A smaller bag can have the dimensions 20 inches by 20 inches by 3 inches, which is 980 square inches in surface area and 1,200 cubic inches of volume for a surface to volume ratio of 0.817. A large bag with the smaller surface to volume ratio may be pressed in a 5-10 minute cycle whereas a smaller bag with the larger surface to volume ratio may be pressed in a cycle that is about two minutes or less. The quicker press cycle for smaller bags can enable the juicing machines described herein to automatically fill the bags with ground food, squeeze the bags to extract the juice, retract the moveable platen, and rotate the trough assembly to dump the leftover cakes from the bags in about 3 minutes or less.

In some implementations, the bags can be oversized, which can include being oversized in comparison to the space for the bags 196 defined by the chamber 188 and the wall inserts 234. The chamber 188 can help contain the oversized bag. The bags 196 can include a large (e.g., oversized) top opening (e.g., mouth) to facilitate the cakes falling out of the bags 196 when inverted. The cake can be rigid (e.g., board like). The cake can include a rectangular cross-section formed by the faces of the wall inserts 234 and walls of the chamber 188. The cake can be thinner compared to the thickness of the ground food prior to pressing but the same width, which is determined by the width of the chamber 188. The opening into the bags 196 can be sized to not impede the dumping of the cake. The opening can be enlarged (e.g., oversized) at least because the chamber 188 contains the bags 196 and/or ground food and cakes during pressing. In designs without a water-tight chamber 188, the bags 196 can protrude outside the periphery of the wall inserts 234 so that portions (e.g., bulges) of ground food are not fully pressed and do not readily fall out of the opening of the bags 196. The bags 196 can fold flat (e.g., collapse) against the walls of the chamber 188.

### I. CERTAIN TERMINOLOGY

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Terms of orientation used herein, such as “top,” “bottom,” “longitudinal,” “lateral,” and “end” are used in the context of the illustrated embodiment. However, the present disclosure should not be limited to the illustrated orientation. Indeed, other orientations are possible and are within the scope of this disclosure. The term “vertical” refers to a direction that is parallel to the direction of the Earth's gravity and the term “horizontal” refers to a direction that is perpendicular to the direction of the Earth's gravity. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

The terms “approximately,” “about,” and “substantially” as used herein represent an amount close to the stated amount that still performs a desired function or achieves a desired result. For example, in some embodiments, as the context may permit, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may permit, the term “generally parallel” can refer to something that departs from exactly parallel by less than or equal to 20 degrees and the term “generally perpendicular” can refer to something that departs from exactly perpendicular by less than or equal to 20 degrees.

### J. SUMMARY

Although the juicing machines, systems, and methods have been disclosed in the context of certain embodiments and examples, the scope of this disclosure extends beyond the specifically disclosed embodiments to other alternative embodiments and/or uses of the embodiments and certain modifications and equivalents thereof. Various features and aspects of the disclosed embodiments can be combined with or substituted for one another in order to form varying modes of the juicing machine. The scope of this disclosure should not be limited by the particular disclosed embodiments described herein.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations. The described components and systems can generally be integrated together in a single product or packaged into multiple products. Additionally, other implementations are within the scope of this disclosure.

Some embodiments have been described in connection with the accompanying drawings. The figures are drawn to scale where appropriate, but such scale should not be interpreted as limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

In summary, various embodiments and examples of juicing machines, systems, and methods have been disclosed. This disclosure expressly contemplates that various features and aspects of the disclosed embodiments can be combined with, or substituted for, one another. Accordingly, the scope of this disclosure should not be limited by the particular disclosed embodiments and examples described above, but should be determined only by a fair reading of the claims that follow.

What is claimed is:

1. A juicing machine comprising:
a grinder configured to ground food;
a press assembly comprising a chamber, a moveable platen disposed in the chamber, and a press shaft, the chamber comprising an outlet and configured to receive the ground food from the grinder, and the press shaft configured to advance the moveable platen to press the ground food received in the chamber to extract juice;
a receptacle configured to receive extracted juice flowing out of the chamber through the outlet; and
a motor configured to rotate the press assembly to an inverted position to dump waste remaining in the chamber from the chamber after the ground food is pressed.

2. The juicing machine of claim 1, further comprising a hopper to receive ground food and a load sensor configured to monitor a weight of food disposed in the hopper.

3. The juicing machine of claim 1, further comprising a load sensor configured to monitor a weight of the food in the chamber.

4. The juicing machine of claim 1, further comprising a plurality of wall inserts and a plurality of bags disposed in the chamber, the plurality of bags disposed between adjacent wall inserts of the plurality of wall inserts and configured to receive the cut food.

5. The juicing machine of claim 4, wherein the plurality of wall inserts are coupled together by linkages.

6. The juicing machine of claim 4, wherein one wall insert of the plurality of wall inserts is coupled to an end wall of the chamber and another wall insert of the plurality of wall inserts is coupled to the moveable platen.

7. The juicing machine of claim 4, further comprising a rod extending through the chamber, wherein the plurality of wall inserts comprise holes configured to receive the rod.

8. The juicing machine of claim 1, further comprising a hopper configured to receive the cut food from the grinder above the press assembly, the hopper comprising a barrier configured to be actuated to cover and uncover an outlet of the hopper.

9. The juicing machine of claim 1, further comprising a screen disposed over the receptacle to impede solids from entering the receptacle.

10. The juicing machine of claim 1, further comprising one or more fluid outlets configured to spray a fluid to clean the press assembly.

11. The juicing machine of claim 10, further comprising one or more pumps to recirculate the fluid back to the one or more fluid outlets.

12. A juicing machine comprising:
a chamber configured to receive food;
a moveable platen disposed in the chamber;
a press shaft configured to advance the moveable platen to press food received in the chamber to extract juice; and
a motor configured to rotate the chamber to an inverted position to dump waste remaining in the chamber after the food is pressed to extract juice.

13. The juicing machine of claim 12, further comprising a load sensor configured to monitor a weight of food disposed in the chamber.

14. The juicing machine of claim 12, further comprising a plurality of wall inserts and a plurality of bags disposed in the chamber, the plurality of bags disposed between adjacent wall inserts of the plurality of wall inserts and configured to receive the food.

15. The juicing machine of claim 14, wherein the plurality of wall inserts are coupled together by linkages.

16. The juicing machine of claim 14, wherein one wall insert of the plurality of wall inserts is coupled to an end wall of the chamber and another wall insert of the plurality of wall inserts is coupled to the moveable platen.

17. The juicing machine of claim 12, further comprising a grinder and a hopper, the grinder configured to cut food, and the hopper configured to receive the cut food from the grinder above the chamber and comprising a barrier configured to be actuated to cover and uncover an outlet of the hopper.

18. The juicing machine of claim 12, further comprising one or more fluid outlets configured to spray a fluid to clean the chamber.

19. The juicing machine of claim 18, further comprising one or more pumps to recirculate the fluid back to the one or more fluid outlets.

20. A juicing machine comprising:
a grinder configured to cut food;
an enclosure;
a press assembly disposed in the enclosure and comprising a water-tight chamber configured to that hold press bags for receiving the cut food, the press assembly configured to press the cut food received in the press bags to extract juice;
one or more fluid outlets disposed in the enclosure, the one or more fluid outlets configured to spray a fluid into the water-tight chamber to clean the bags; and
one or more pumps configured to recirculate the fluid back to the one or more fluid outlets.
